(19) United States
(12) Patent Application Publication
(10) Pub. No.: US 2021/0111445 A1
(43) Pub. Date: Apr. 15, 2021

(54) SYSTEMS AND METHODS FOR REGENERATION OF LITHIUM CATHODE MATERIALS

(71) Applicant: THE REGENTS OF THE UNIVERSITY OF CALIFORNIA, Oakland, CA (US)

(72) Inventors: Zheng CHEN, San Diego, CA (US); Yang SHI, San Diego, CA (US)

(21) Appl. No.: 16/960,284

(22) PCT Filed: Jan. 7, 2019
(86) PCT No.: PCT/US2019/012572

§ 371 Date: Jul. 6, 2020

Related U.S. Application Data
(60) Provisional application No. 62/682,822, filed on Jun. 8, 2018.
(60) Provisional application No. 62/614,300, filed on Jan. 5, 2018.

(51) Int. Cl. H01M 10/54; H01M 10/0525; C01G 45/12

(52) U.S. Cl. CPC H01M 10/54; C01G 45/1221; H01M 10/0525

(57) ABSTRACT

Methods for regenerating degraded cathode particles in lithium-ion batteries are provided through a combination of hydrothermal treatment of cycled electrode particles followed by short thermal annealing. The methods provide for directly regenerating high-performance LiCoO2 (LCO) and LiNixCoyMnzO2 (NCM) cathodes. Combining hydrothermal treatment with short thermal annealing to regenerate degraded LCO particles provides successful reconstruction of stoichiometric composition and desired crystalline structure from severely degraded cathode materials, and in further embodiments, successful regeneration of degraded NCM cathodes is demonstrated, which regenerates degraded NCM particles with electrochemical performance reaching that of new cathode materials.

### RELATED APPLICATIONS

This application is related to U.S. provisional application No. 62/614,300, filed Jan. 5, 2018, and U.S. provisional application No. 62/682,822, filed Jun. 8, 2018 the contents of which are incorporated herein by reference in their entirety.

### FIELD OF THE INVENTION

The present invention relates to systems and method for recycling and regenerating lithium-ion batteries using an approach that is non-destructive, effective, energy efficient, environmentally friendly, and amenable to industrial mass production.

### BACKGROUND

With the growing applications of lithium-ion batteries (LIBs) in many areas, their recycling becomes a necessary task. Although great effort has been made on LIB recycling, there remains an urgent need for green and energy-efficient approaches.

LIBs have been widely used in mobile electronics, electric vehicles (EVs) and renewable grids due to their high energy density. Typical LIBs will reach their lifetime after a few years of service due to performance degradation. It is projected that ˜1 million tons of used LIBs will be extracted from the market by 2025. From the economic point of view, reuse of the precious metals (e.g. $90/kg for Co, $14/kg for Ni, $20/kg for Li) from LIBs can significantly reduce their cost because a significant portion (30-40%) of the LIB cost comes from their cathode materials. From the environmental point of view, the flammable and toxic wastes (organic solvents, heavy metals) generated from disposal of used batteries can cause severe environment pollution. Therefore, it becomes strongly desired to recycle, reuse and re-manufacture LIBs for sustainable energy storage.

While less than 5% of used LIBs are recycled today, there has been increasing studies of various recycling technologies. Among different cathode materials, LiCoO₂ is the most extensively studied one since it is the first-generation of LIB cathode and has been the dominating cathode material in LIBs for mobile electronics due to its high volumetric and gravimetric energy density. The most common approaches for LiCoO₂ recycling are based on chemical leaching followed by electrolysis or chemical precipitation. For example, Zou et al. developed a practical process to recycle various cathode materials including LiCoO₂ with high efficiency by pH-controlled precipitation. Corrosive acids are used in such recycling process which requires careful neutralizing treatment to recover the digested metals. Meanwhile, this procedure requires multiple complicated steps to maximize the recovery efficiency and reduce the waste generation. More importantly, the embedded energy in the desired cathode particles is lost during such a destructive recycling process.

Researchers are also trying to develop simple and low-cost recycling approaches. Recently solid-state synthesis method has also been used, in which LiCoO₂ harvested from spent LIBs is sintered with a pre-determined amount of Li salt (e.g. Li₂CO₃). The synthesis approach is relatively simple, however the Li/Co ratio must be accurately measured before the dosage of Li₂CO₃ is determined. The potential limitation of this approach is that the regeneration conditions may differ between each individual cell because the Li/Co ratio changes with the cycling history from cell to cell. An aqueous pulsed discharge plasma approach to renovate LiCoO₂ has also been developed, which allows batch processing of spent LIBs. However, the electrochemical performance of renovated LiCoO₂ is not ideal since the first discharge capacity is only 126.7 mAh g⁻¹ at C/5 (140 mAh g⁻¹ is often expected for fresh LiCoO₂ based on 0.5 Li⁺ reaction). Similarly, an ultrasonic irradiation approach can only generate recovered LiCoO₂ with a first discharge capacity of 131.8 mAh g⁻¹ at C/5. In short, even though great effort has been made to recycle and regenerate LiCoO₂ cathode material, an environmental benign approach that both guarantees high electrochemical performance and allows easy processing is still urgently needed.

In addition to the most extensively studied LCO, layered oxide LiNiₓCo_{y}Mn_{z}O₂ (0<x,y,z<1, x+y+z=1) (NCM) is becoming the dominating cathode material in the state-of-the-art LIBs due to the high capacity and reduced cost. NCM has degradation issues after cycling due to the Li loss and phase changes. So far, the recycling of NCM cathodes has been mainly based on the hydrometallurgical process. Directly resolving these issues to generate new NCM cathodes can not only reduce the high cost but also prevent environmental pollution from disposal of used LIBs. However, currently there is no effective approach to tackle this challenge. Therefore, there is an urgent need to develop a more energy-efficient, non-destructive process to directly recycle NCM cathodes.

### SUMMARY

Systems and methods are provided for recycling and regenerating lithium-ion batteries by combining hydrothermal treatment of cycled electrode particles with short thermal annealing to directly regenerate degraded LiCoO₂ (or LCO) and LiNiₓCo_{y}Mn_{z}O₂ (or NCM) cathode materials. Combining hydrothermal treatment with short thermal annealing to regenerate degraded LiCoO₂ particles provides successful reconstruction of stoichiometry composition, desired crystalline structure and superior electrochemical performance from severely degraded cathode materials, and in further embodiments, successful regeneration of degraded NCM cathodes delivers NCM particles with recovered stoichiometry composition, desired crystalline structure and electrochemical performance reaching that of new NCM cathode materials.

In one embodiment, a method for regenerating degraded LiCoO₂ (LCO) cathode materials comprises: pre-dosing lithium (Li) into Li-deficient cathode particles in a Li-containing salt solution; performing a hydrothermal treatment on the salt solution; and thermally annealing the hydrothermally treated salt solution to create regenerated cathode particles.

In another embodiment, a method for regenerating degraded LiNiₓCo_{y}Mn_{z}O₂ (NCM) cathode particles comprises: pre-dosing lithium (Li) into Li-deficient cathode particles in a Li-containing salt solution; exposing the Li-containing salt solution to a hydrothermal treatment; and thermally annealing the hydrothermally treated salt solution to produce regenerated cathode particles.

Regenerated LiCoO₂ particles from spent lithium-ion batteries (LIBs) retain their original morphology and structure and provide high specific capacity and cycling stability. Importantly, they show much better rate capability than particles regenerated through the solid-state synthesis approach. Unlike the conventional chemical leaching or solid-state synthesis approach, which either requires complicated steps of leaching, precipitation and waste treatment or relies on chemical analysis of Li/Co ratio from cell to cell, this non-destructive approach is much simpler and more environmental friendly, and can easily process batteries with different capacity degradation conditions. The methods demonstrate a greener, simpler and more energy-efficient strategy to recycle and regenerate faded LiCoO₂ cathode materials with high electrochemical performance. This approach can be widely used to recycle and regenerate LiCoO₂ cathode in a large scale, and can be potentially applied to other types of cathode materials in LIBs and mixed cathode chemistry.

The successful regeneration of degraded NCM cathodes is demonstrated as well. Using non-destructive methods, nearly ideal stoichiometry, low cation mixing and high phase purity were achieved in the regenerated NCM particles, which offer high specific capacity, cycling stability and rate capability reaching pristine materials. This represents a simple yet efficient approach to directly regenerate high-performance NCM cathodes with distinct advantages over traditional hydrometallurgical methods, and builds an important foundation for the sustainable manufacturing of energy materials.

### BRIEF DESCRIPTION OF THE DRAWINGS

FIGS. 1A, 1B and 1C illustrate a recycling and regeneration procedure for a battery, according to one embodiment of the invention;

FIG. 1D is a graphical illustration of cell capacity retention after a number of cycles, according to one embodiment of the invention;

FIGS. 2A and 2B show scanning electron microscope (SEM) images (upper panel) and particle size distributions (lower panel) of fresh and cycled LiCoO₂ particles and samples regenerated at two different conditions, according to one embodiment of the invention;

FIGS. 2C and 2D show SEM images and particle size distributions of LiCoO₂ particles regenerated at other conditions, according to one embodiment of the invention;

FIGS. 3A-3C illustrate a comparison of XRD patterns of fresh, cycled and regenerated LiCoO₂ materials under different conditions, according to one embodiment of the invention;

FIGS. 4A-4B illustrate Raman spectra of a cycled (4A) and regenerated LiCoO₂ cathode by a hydrothermal and short annealing process (4B), according to one embodiment of the invention;

FIG. 5 illustrates the cycling performance of regenerated LiCoO₂ using several different methods, according to one embodiment of the invention;

FIG. 6 illustrates a rate performance of LiCoO₂ regenerated with different methods, according to one embodiment of the invention;

FIG. 7 illustrates Nyquist plots of regenerated LiCoO₂ after 100 cycles by different methods, according to one embodiment of the invention;

FIG. 8A illustrates cycling and rate performance of recycled LiCoO₂ treated with pure LiOH and mixed Li salt, according to one embodiment of the invention;

FIG. 8B illustrates XRD patterns of cycled and regenerated LiCoO₂, according to one embodiment of the invention;

FIG. 8C illustrates cycling performance of pristine and hydrothermal-regenerated LiCoO₂ powders, according to one embodiment of the invention;

FIG. 8D illustrates cycling and rate performance of pristine LiCoO₂ and pristine LiCoO₂ sintered with 5% excess Li, according to one embodiment of the invention;

FIG. 8E illustrates XRD patterns of the pristine and regenerated NCM, according to one embodiment of the invention;

FIG. 8F illustrates the cycling performance of the pristine and regenerated NCM, according to one embodiment of the invention;

FIG. 9 illustrates voltage capacity profiles and cycling performance of a pristine and regenerated LCO−NCM mixed cathode, as well as HR-TEM images and FFTs of cycled and regenerated LiNi_{1/3}Co_{1/3}Mn_{1/3}O₂ (NCM111) particles, according to one embodiment of the invention;

FIG. 10 illustrates an exemplary method of regenerating degraded NCM cathode materials using a particle-to-particle approach, according to one embodiment of the invention;

FIG. 11 is a graphical illustration of cell capacity retention of cycling performance of a LiNi_{0.5}Co_{0.2}Mn_{0.3}O₂ (NCM523) pouch cell, according to one embodiment of the invention;

FIGS. 12A -12F show SEM images (A, C), particle size distributions (B, D) and high resolution-transmission electron microscope (HR-TEM) images of pristine NCM523 particles (E) and cycled/degraded NCM523 particles (F), according to one embodiment of the invention;

FIG. 13A and 13B show SEM images (upper panel) and particle size distributions (lower panel) of NCM111 particles, according to one embodiment of the invention;

FIG. 14 shows HR-TEM and Fast Fourier Transform (FFT) images of pristine NCM111 particles, according to one embodiment of the invention;

FIG. 15 shows HR-TEM and FFT images of cycled NCM111 particles, according to one embodiment of the invention;

FIG. 16A illustrates a hydrothermal lithiation process of degraded LIB cathode particles during hydrothermal treatment, according to one embodiment of the invention;

FIG. 16B illustrates hydrothermal lithiation kinetics of degraded LIB cathode particles during hydrothermal treatment, according to one embodiment of the invention;

FIGS. 17A and 17B illustrate a comparison of XRD patterns of pristine, cycled and regenerated NCM111 and NCM523 materials under different conditions, according to one embodiment of the invention;

FIGS. 18A-18E illustrate a Rietveld refinement of the XRD patterns of pristine, cycled and regenerated NCM111 cathodes, according to one embodiment of the invention;

FIGS. 18A-18E illustrate a Rietveld refinement of the XRD patterns of pristine, cycled and regenerated NCM111 cathodes, according to one embodiment of the invention;

FIGS. 19A-19E illustrate a Rietveld refinement of the XRD patterns of pristine, cycled and regenerated NCM523 cathodes, according to one embodiment of the invention;

FIGS. 20A-20F show SEM images (A), particle size distribution (B), HR-TEM images (C-E) and X-ray photoelectron spectroscopy (XPS) spectra (F) of regenerated NCM523 cathodes by different approaches, according to one embodiment of the invention;

FIG. 21 shows HR-TEM and FFT images of cycled NCM523 particles after hydrothermal treatment only, in which both amorphous and crystalline domains at the surface of particles were observed, according to one embodiment of the invention;

FIG. 22 shows HR-TEM and FFT images of cycled NCM111-hydrothermal-short annealing (HT-SA) particles, according to one embodiment of the invention;

FIG. 23 shows HR-TEM and FFT images of cycled NCM111-solid state sintering in air (SS-air) particles, according to one embodiment of the invention;

FIG. 24 shows HR-TEM and FFT images of cycled NCM111-solid state sintering in oxygen (SS-O₂) particles, according to one embodiment of the invention;

FIG. 25 illustrates XPS patterns of pristine NCM111, cycled NCM111, NCM111-HT-SA and NCM111-SS-O₂ samples, according to one embodiment of the invention;

FIG. 26A illustrates cycling performance of pristine, non-treated and regenerated NCM111 samples, according to one embodiment of the invention;

FIG. 26B illustrates cycling performance of pristine, non-treated and regenerated NCM523 samples, according to one embodiment of the invention;

FIG. 26C illustrates rate performance of NCM111 samples, according to one embodiment of the invention;

FIG. 26D illustrates rate performance of NCM523 samples, according to one embodiment of the invention;

FIG. 26E illustrates voltage profiles of NCM111 samples, according to one embodiment of the invention;

FIG. 26F illustrates voltage profiles of NCM523 samples, according to one embodiment of the invention;

FIG. 26G illustrates the crystal structure change of NCM523 after cycling and regeneration, according to one embodiment of the invention; and

FIG. 27 illustrates Nyquist plots of regenerated NCM523 cathodes after 100 cycles, according to one embodiment of the invention.

### DETAILED DESCRIPTION OF EMBODIMENTS

I. Regenerating Degraded LiCoO₂ Particles

In an illustrative implementation of the inventive system and method, a simple yet efficient non-destructive cathode recycling approach is provided for generating high-capacity and high-rate active particles using LiCoO₂ as the model material. Hydrothermal reaction is widely used in the synthesis of various cathode materials and has the capability of generating particles with high crystallinity and desired stoichiometry. Here, we took the advantage of this process to pre-dose Li into Li-deficient cathode particles without concern about the Li/Co ratio. Then we combined hydrothermal treatment with simple thermal annealing to regenerate LiCoO₂ with desired microstructure and composition, which lead to outstanding electrochemical performance. Compared with the previous approaches, this strategy shows several major advantages: i) it does not require tedious chemical analysis to determine the amount of Li⁺ loss, and is compatible with batteries at different capacity fading conditions; ii) it does not require long-time, energy-consuming sintering treatment since Li⁺ is dosed with the correct stoichiometry during the hydrothermal process; and iii) the regenerated active particles have high capacity and improved rate capability compared with solid-state synthesis approach.

A. Experimental

### (a) LiCoO₂ Cell Cycling and Cathode Materials Harvesting

Commercial LiCoO₂ cells: Pouch cells with LiCoO₂ as the cathode and graphite as the anode were purchased from MTI Corporation (www.mtixtl.com) (2 Ah, EQ-PL-605060-2C). The pouch cells were cycled in the voltage range of 3-4.5 V using a LAND battery tester for 200 cycles and discharged to 2 V at C/10 (1C=150 mA g⁻¹) before disassembly. The cathode strips were harvested from the pouch cells, by thoroughly rinsing with dimethyl carbonate. After drying, the cathode strips were soaked in N-Methyl-2-pyrrolidone (NMP) for 30 min followed by sonication for 20 min. The LiCoO₂ powders, binder and carbon black were removed from the aluminum substrates. The obtained suspension was centrifuged at 3500 rpm for 5 min and LiCoO₂ powders were precipitated, separated and dried for regeneration. Fresh pouch cells were directly discharged to 2 V at C/10 without any cycling before disassembly and the harvested LiCoO₂ material serves as the reference material for comparison.

Home-made LiCoO₂ cells: As a comparison, we also built cells from pristine LiCoO₂ powders (MTI Corporation) to perform cycling and harvesting active cathode particles after capacity fading. To fabricate thick electrodes, LiCoO₂ powders were mixed with polyvinylidene fluoride (PVDF), and carbon black (Super P65) in NMP at a mass ratio of 93:4:3 to form homogenous slurries. Then the slurries were cast on aluminum foil using a doctor blade and dried in vacuum at 80° C. for 6 h. Circle electrodes were cut and compressed by rolling mill. The active mass loading was about 28 mg/cm². 2016-type coin cells were assembled with Li metal disc (thickness 1.1 mm) as anode, 1 M LiPF₆ in ethylene carbonate and diethyl carbonate (EC:DEC 1:1 wt.) as the electrolyte, and tri-layer membrane (Celgard 2320) as the separator. The cells were cycled in the voltage range of 3-4.5 V to gain >50% capacity loss and then discharged to 2 V at C/10. The following harvesting procedure was the same as stated previously. These materials will be used to validate the regeneration procedure, and also compare the electrochemical performance of the pristine LiCoO₂ powder and regenerated cathodes from commercial pouch cells.

Home-made LiNi_{1/3}Co_{1/3}Mn_{1/3}O₂ (NCM) and mixed pouch cells: To demonstrate that this approach can be potentially used in mixed cathode chemistry, we built home-made pouch cells from pristine NCM powder (Toda America) and mixed pristine LiCoO₂-NCM powders with an active mass ratio of 1:1. The electrodes fabrication procedure, electrolyte and separator are the same as in the home-made LiCoO₂ cells. Pouch cells were assembled with Li metal foil (thickness 0.75 mm) as anode, and a typical pouch cell had an electrode area of 20 mm×55 mm. The cells were cycled in the voltage range of 3-4.5V to gain >40% capacity loss and then discharged to 2 V at C/10. The following harvesting procedure was the same as stated previously. These materials will be used to demonstrate the feasibility of this technique to regenerated mixed cathode materials.

### (b) LiCoO₂ Regeneration

Two different cathode regeneration methods were used to compare their operation characteristics and the electrochemical performance of the regenerated products.

Combined hydrothermal treatment and short annealing: For hydrothermal treatment, LiCoO₂ powders harvested from cycled cells were loaded into a 100 mL Teflon-lined autoclave filled with 80 mL of 4 M lithium hydroxide (LiOH) solution, or a mixed solution of 1 M LiOH and 1.5 M Li₂SO₄. In some embodiments, a lithium containing solution can be made by a small concentration (e.g., 0.1M) of lithium salt (e.g., LiOH, Li₂SO₄, LiCl, LiNO₃), and may also be mixed with an alkaline solution from NaOH, KOH, NH₄OH or their mixture. The autoclave was kept at a wide range of temperatures and times. The treated LiCoO₂ powders were washed thoroughly with deionized water, dried and then annealed at different temperatures with a ramping rate of 5° C./min.

Solid-state synthesis: For LiCoO₂ regeneration from solid-state synthesis, the compositions of Li and Co of cycled cathode materials were first measured by an inductively coupled plasma optical emission spectrometer (ICP-OES, Perkin Elmer Optima 3000 DV). The harvested cathode powders were mixed with Li₂CO₃ with agate mortar and pestle. The amount of Li₂CO₃ was calculated to obtain the mixture with a Li/Co ratio of 1.05. The 5% excess amount of Li was added to compensate the Li evaporation during the sintering process. The mixtures were sintered at different temperatures and times with a ramping rate of 5° C./min.

### (c) Characterization of Regenerated LiCoO₂ and NCM

The morphology of LiCoO₂ powders was observed by Ultra High-Resolution Scanning Electron Microscope (UHR SEM, FEI XL30). The particle size distribution is analyzed with Nano Measurer. The crystal structure of the powders was examined by X-ray Powder Diffraction (XRD) employing Cu K_{α} radiation. Raman spectroscopy was recorded using a Renishaw inVia confocal Raman Microscope. Spectra were collected between 300 and 900 cm⁻¹ with a 633-nm laser. The crystal structure of the cycled and regenerated NCM materials were examined by Transmission Electron Microscopy (TEM) (FEI Titan 80-300 kV S/TEM).

### (d) Electrochemical Performance Characterization

To evaluate electrochemical performance, the regenerated and non-treated LiCoO₂ powders were mixed with PVDF and Super P65 in NMP at a mass ratio of 8:1:1. The resulted slurries were cast on aluminum foils followed by vacuum drying at 80° C. for 6 h. Circle electrodes were cut and compressed, with controlled active mass loading of about 3 mg/cm². Cells were fabricated by the same procedure as thicker electrodes mentioned above. Galvanostatic charge-discharge was carried out in the potential range of 3-4.3 V. The electrochemical impedance spectroscopy (EIS) tests were performed at discharged state in the frequency range of 10⁶ Hz to 10⁻³ Hz with signal amplitude of 10 mV by a Metrohm Autolab potentiostat.

B. Results and Discussion

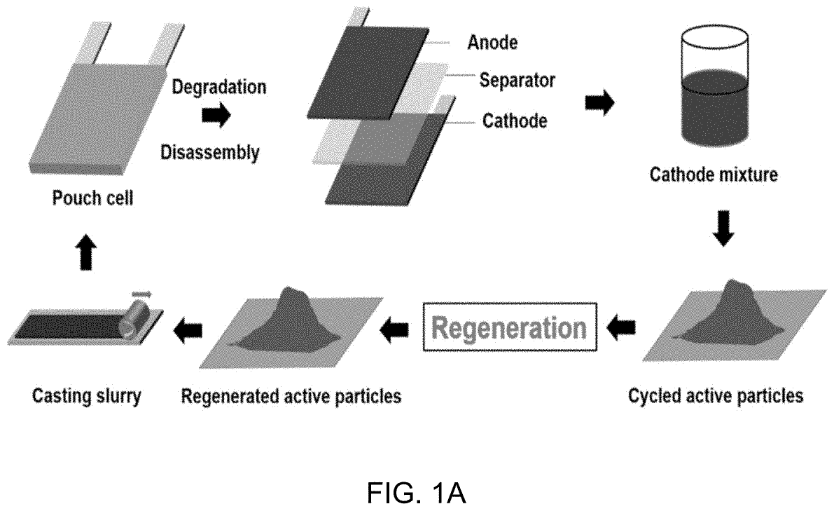

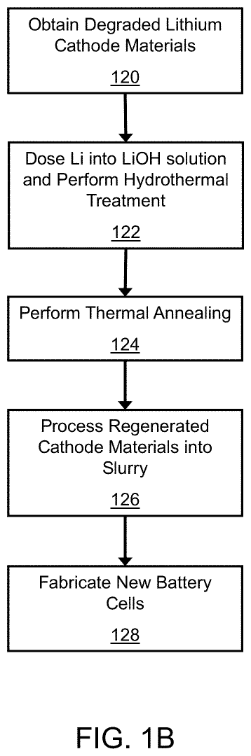

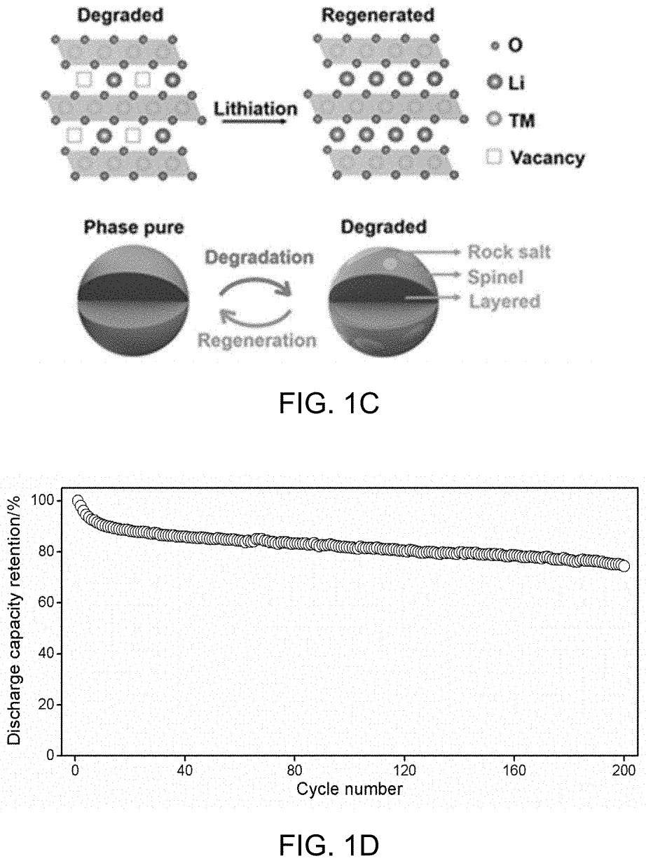

The overall recycling and regeneration procedure are illustrated in FIG. 1A. In general, cycled cells with significant capacity degradation were disassembled and electrodes strips were harvested. The cathodes were washed by NMP and active material powders were collected. The obtained powders were subject to different regeneration treatments either by hydrothermal treatment with short annealing or solid-state synthesis. The regenerated cathode materials were made into slurries to fabricate new cells. In this work, coin cells were assembled to evaluate the electrochemical performance of the regenerated cathode material for the sake of convenience and consistence.

FIG. 1B illustrates an exemplary method of regenerating cathode materials, according to one embodiment of the invention. As mentioned above, in step 120, degraded cathode materials must first be collected from cycled cells. In step 122, lithium (Li) is pre-dosed into Li-deficient cathode particles via a lithium hydroxide solution and the cathode particles with the lithium hydroxide solution are hydrothermally treated for a specified time and at a specified temperature. In step 124, thermal annealing is performed on the hydrothermally treated cathode particles to complete the regeneration of the cathode particles. In step 126, the new regenerated cathode particles are formed into a slurry, which, in step 128, can be used to fabricate new battery cells.

To produce faded cathode materials, commercial pouch cells with LiCoO₂ as the cathode active material were cycled in the voltage range of 3-4.5 V to speed up the capacity fading. The resulted cell capacity retention was 74% after 200 cycles, as illustrated by the discharge capacity retention graph in FIG. 1D. The cycled cathode serves as a proper material for recycling and regeneration purpose. Two methods were used to regenerate cycled LiCoO₂. For hydrothermal treatment combined with short annealing, it is speculated that the following reaction happens during the hydrothermal step:

$${Li}_{x} {CoO}_{2} + ( 1 - x ) LiOH + \frac{x - 1}{4} {O}_{2} \to {LiCoO}_{2} + \frac{1 - x}{2} {H}_{2} O \qquad ( 1 )$$

The following short annealing step can increase the crystallinity and eliminate structure defects. For the solid-state synthesis approach with long-term sintering, the following reactions happen:

$$\begin{matrix}{Li}_{x} {CoO}_{2} \to \frac{1 - x}{3} {Co}_{3} {O}_{4} + {x LiCoO}_{2} + \frac{1 - x}{3} {O}_{2} & ( 2 ) \\ 2 {Co}_{3} {O}_{4} + 3 {Li}_{2} {CO}_{3} + \frac{1}{2} {O}_{2} \to 6 {LiCoO}_{2} + 3 {CO}_{2} & ( 3 )\end{matrix}$$

where x (0.5<x<1) is the mole number of Li in the cathode. LiₓCoO₂ starts to release oxygen at 220° C. and forms Co₃O₄, which is later reacted with Li₂CO₃ to form LiCoO₂ again.

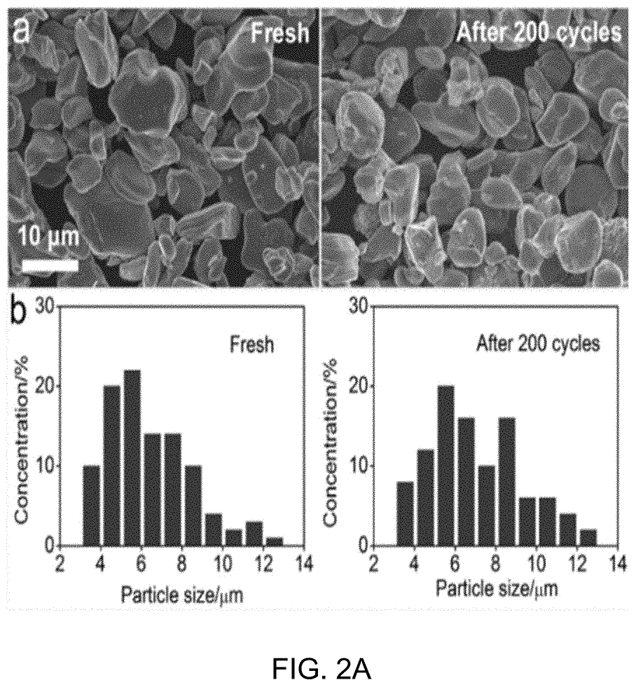

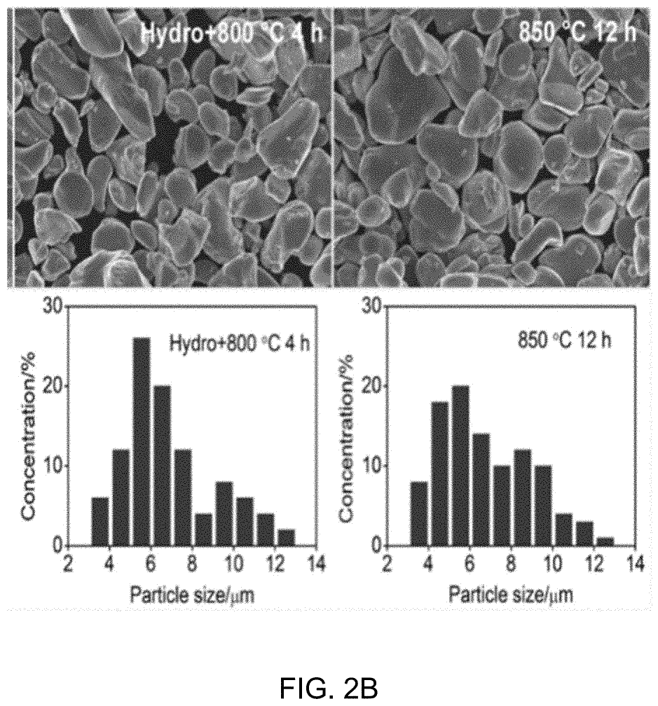

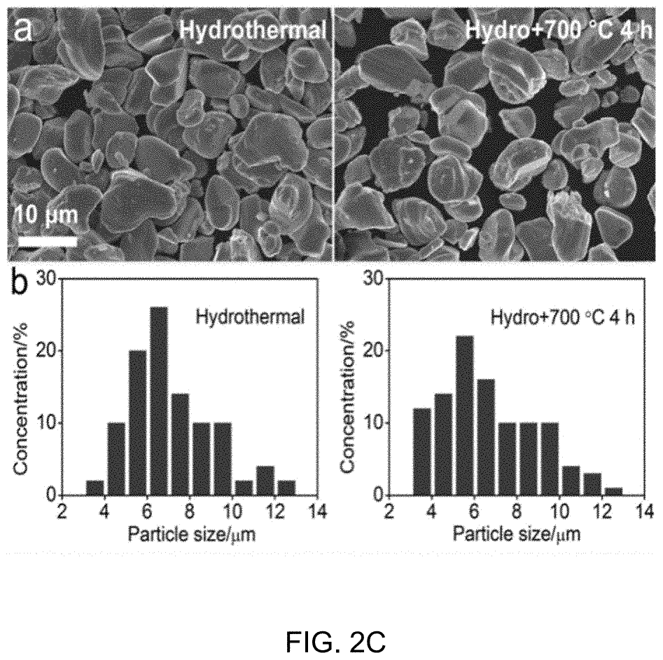

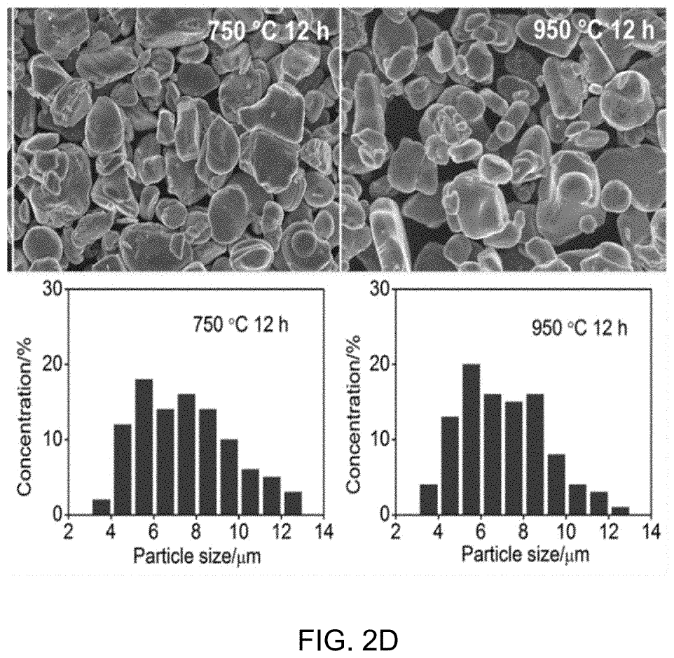

The morphology and particle size of the LiCoO₂ powders remained nearly the same after cycling and regeneration under different conditions. FIGS. 2A and 2B show SEM images and size distributions of fresh and cycled LiCoO₂ particles, as well as samples regenerated at two different conditions. The SEM images and size distributions of LiCoO₂ particles regenerated at other conditions are shown in FIGS. 2C and 2D. All the samples show similar morphology and particle size distribution, suggesting that the regeneration approach does not affect their morphology and sizes.

It has been demonstrated that the capacity fading of LiCoO₂ is mainly contributed by the Li⁺ loss and the increases of solid-electrolyte interface (SEI). The Li⁺ loss of the cycled pouch cell was evidenced by the Inductively Coupled Plasma (ICP) result, showing a Li/Co ratio decreased from 0.99 to 0.80 after 200 cycles. For the regeneration process, the target ratio of Li/Co is 1 and the compositions of the cathode materials regenerated by different processes are listed in Table 1.

TABLE 1
ICP results of regenerated cathode
materials from different conditions.

| | | | |
|---|---|---|---|
| Hydrothermal | No annealing | 700° C. 4 h | 800° C. 4 h |
| Composition | Li_{0.98}CoO₂ | Li_{0.98}CoO₂ | Li_{0.98}CoO₂ |
| Solid-state | 750° C. 12 h | 850° C. 12 h | 950° C. 12 h |
| synthesis | Li_{0.99}CoO₂ | Li_{0.98}CoO₂ | Li_{0.96}CoO₂ |
| Composition | | | |

For the hydrothermal treatment with an approximately 4 mole (M) lithium hydroxide (LiOH) solution, an excess amount of Li source is provided in the aqueous phase, which promotes the lithiation of cycled LiCoO₂ to reach targeted stoichiometry without controlling the ratio between Li and Co. One major advantage of this step is that degraded LiCoO₂ with any Li/Co ratio can be processed together. The Li/Co ratio remains the same in the regenerated particles after short annealing process. For comparison, in solid-state synthesis, the ratio between Li₂CO₃ and the cycled LiCoO₂ (Li-deficient) needs to be carefully controlled to reach a desired composition after long-time sintering. Also, it is shown that the final Li/Co ratio obtained after solid-state synthesis decreases as the sintering temperature increases due to Li evaporation during long-term sintering, which is consistent with literature.

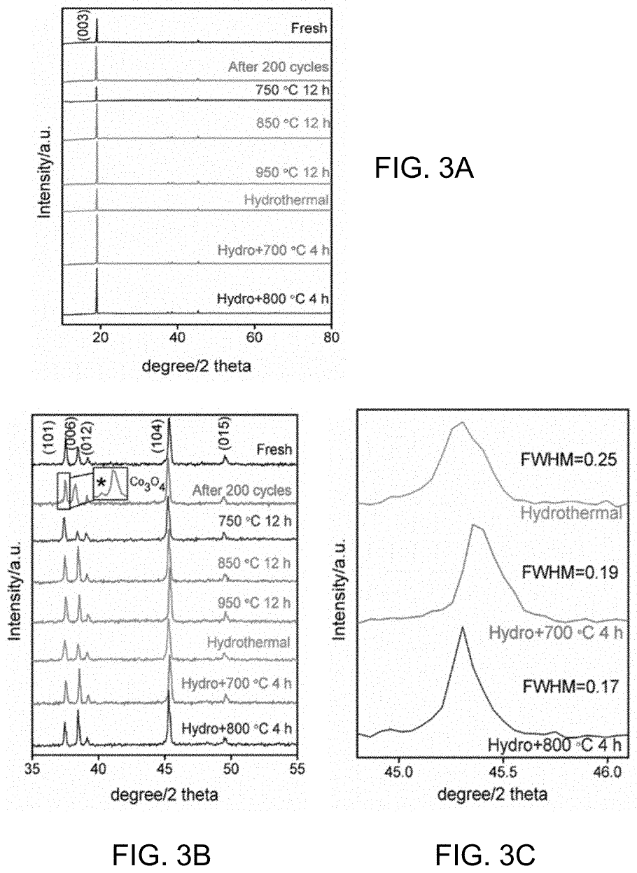

Phase transitions also take place in Li⁺-deficient LiₓCoO₂ during cycling (x is the mole number of Li). According to the phase diagram of LiₓCoO_{2,}²⁶ for 0.5<x<1, layered LiCoO₂ transforms to cubic spinel LiCo₂O₄, and for x<0.5, spinel Co₃O₄ is also formed besides LiCo₂O₄. Another major degradation mechanism of LiCoO₂ is that the low Li⁺ conductivity of the spinel LiCo₂O₄ and Co₃O₄ phases increases the polarization which also contributes to the extra capacity loss. The XRD patterns of fresh, cycled and regenerated LiCoO₂ materials are compared in chart A in FIG. 3. All the LiCoO₂ materials have very high intensity ratio I₍₀₀₃₎/I₍₁₀₄₎, which corresponds to well-defined layered structure. For better comparison, enlarged views of the patterns in the range of 35-55° are displayed in chart B of FIG. 3. For LiCoO₂ after 200 cycles, a small diffraction peak of Co₃O₄ can be detected, which is consistent with literature. The signal of LiCo₂O₄ cannot be observed separately due to its similar peak positions with LiCoO₂. After regeneration from both processes, the peak of Co₃O₄ all disappears, indicating a successful re-construction of the layered structure.

The XRD patterns are further analyzed by Rietveld refinement and the results are displayed in Table 2.

TABLE 2
Lattice parameters of fresh, cycled and
regenerated cathode materials.

| Sample | a/Å | c/Å | R_{B} | R_{wp} |
|---|---|---|---|---|
| Fresh | 2.8114(8) | 14.010(9) | 2.60% | 2.37% |
| After 200 cycles | 2.8103(4) | 14.118(5) | 0.89% | 1.86% |
| 750° C. 12 h | 2.8119(9) | 14.039(3) | 2.29% | 1.95% |
| 850° C. 12 h | 2.8136(7) | 14.014(1) | 1.52% | 2.43% |
| 950° C. 12 h | 2.8141(1) | 14.043(8) | 1.53% | 2.07% |
| Hydrothermal | 2.8150(3) | 14.053(2) | 1.15% | 2.02% |
| Hydro 700° C. 4 h | 2.8146(7) | 14.044(2) | 0.97% | 2.73% |
| Hydro 800° C. 4 h | 2.8133(1) | 14.040(0) | 1.12% | 3.47% |

The Bragg factor (R_{B}) and weighted profile R-factor (R_{wp}) are both below 4%. The Li⁺-deficient cathode after 200 cycles has decreased lattice a and increased c values compared with the fresh cathodes, which are attributed to smaller ionic radius of Co⁴⁺ than Co³⁺, and stronger electrostatic repulsion between the layers due to loss of Li⁺, respectively.

For the hydrothermal treatment approach, several regeneration conditions were tested: some cycled cathode materials were regenerated only through the hydrothermal treatment for comparison, while some materials were annealed at 700° C. and 800° C. after the hydrothermal treatment to increase the crystallinity. The increased crystallinity is confirmed by the decreased lattice a and c parameters after annealing due to a tighter pack of atoms, as well as the decrease in full width at half maximum (FWHM), as illustrated in chart C of FIG. 3, which is consistent with literature. For the solid-state synthesis approach, the regenerated LiCoO₂ has larger lattice parameters a and c at higher sintering temperature which leads to the lattice expansion.

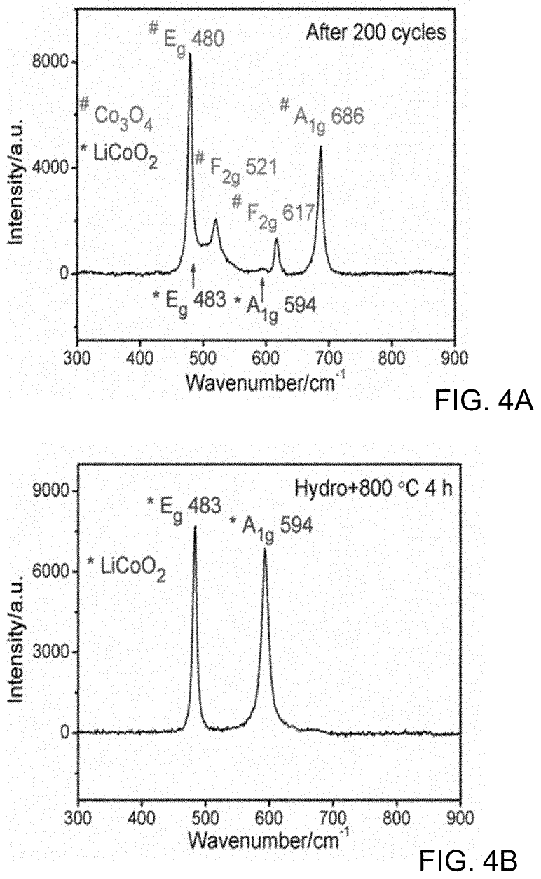

Raman spectra further prove the existence of Co₃O₄ phase in the cathode after 200 cycles and its conversion to LiCoO₂ after regeneration, as illustrated by the spectral charts in FIGS. 4A-4B. For the cathode materials after 200 cycles, the bands at 480, 521, 617 and 686 cm⁻¹ are attributed to Co₃O₄. In the regenerated cathode through hydrothermal approach with short annealing, these bands disappeared and only two bands at 483 and 592 cm⁻¹ are observed, which correspond to E_{g} and A_{1g} modes of LiCoO₂. These results further confirm that Co₃O₄ is fully converted to LiCoO₂ after regeneration.

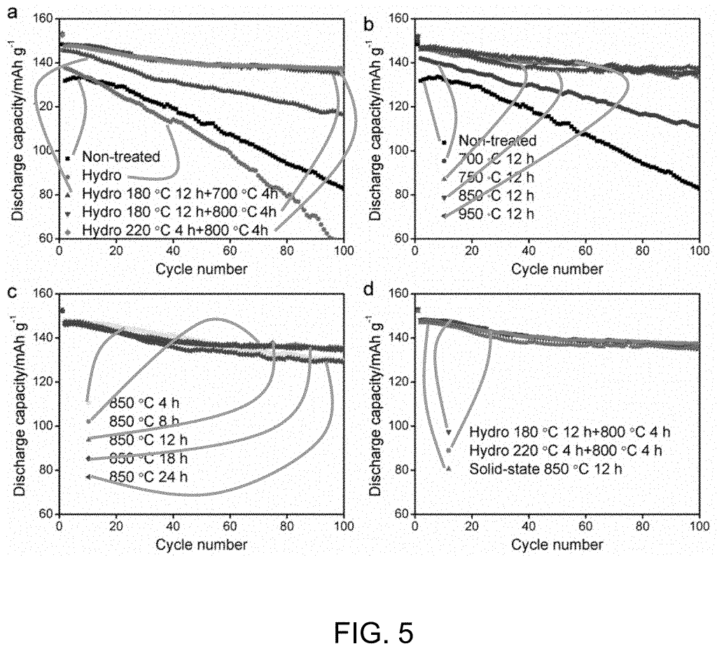

The cycling performance of the regenerated LiCoO₂ through both hydrothermal treatment with short annealing and solid-state synthesis is illustrated by the chart A in FIG. 5. Reference cells with non-treated cathode directly harvested from the cycled pouch were also assembled. The coin cells were cycled at C/10 (1C=150 mA g⁻¹) for the first cycle as activation, and 1C for the following cycles. Chart A illustrates that the regenerated LiCoO₂ through hydrothermal treatment show different cycling performance under different conditions. The sample that only experienced the hydrothermal treatment shows poor cycling stability, even worse than the non-treated material. It is noted that in the XRD patterns the I₀₀₃/I₁₀₄ ratio of the cathode after only hydrothermal treatment is smaller than the cycled non-treated cathode (FIG. 3A), which indicates a poorer hexagonal ordering. It is known that LiCoO₂ processed at low temperature (below 400° C.) often exhibit cation disorder, which cannot keep structural stability that guarantees repeated insertion and removal of Li⁺. The annealing at appropriate temperature greatly enhanced the capacity retention due to increased cation ordering. After annealing at 700° C. for 4 h, the cycling stability is improved but still not ideal. After slightly increased the temperature to 800° C., the regenerated LiCoO₂ after 4 h annealing achieves a significantly improved cycling performance, with a discharge capacity of 153.1 mAh g⁻¹ in the initial cycle at C/10. After increasing the rate to 1C, the capacity is 148.2 mAh g⁻¹ and it can be still maintained on 135.1 mAh g⁻¹ after 100th cycles, corresponding to a retention rate of 91.2%. An annealing temperature higher than 800° C. may also be applied, while 800° C. is sufficient to guarantee good cycling performance. The hydrothermal treatment parameters were further optimized by significantly decreasing the treatment time from 12 h to only 4 h, and increasing the hydrothermal temperature from 180° C. to 220° C. while maintaining the same short annealing step. The regenerated material under this improved condition still maintains the same stable cycling performance, as shown in Chart A of FIG. 5.

The regenerated LiCoO₂ from solid-state synthesis under different conditions are also compared in Chart B of FIG. 5. The initial discharge capacities for LiCoO₂ sintered at 750° C., 850° C., and 950° C. are 152.0, 152.1 and 151.1 mAh g⁻¹, with discharge capacities on the 100th cycle of 133.2, 135.4 and 136.5 mAh g⁻¹, respectively, which are similar to the capacity and cycling performance of samples regenerated by hydrothermal treatment with short annealing at 800° C. The slight difference in capacity retention can be due to variations in cell assembly. The solid-state synthesis at 700° C. was also performed as a comparison and the discharge capacity is 149.8 mAh g⁻¹ in the initial cycle and 111.1 mAh g⁻¹ in the 100th cycle, which shows poor cycling stability. This is due to the fact that 700° C. is lower than the melting point of Li₂CO₃ (723° C.) and the melting of Li₂CO₃ is required for its reaction with Co₃O₄.³⁷ This result is in coincidence with the annealing experiment for the hydrothermal samples. Since solid-state synthesis at 850° C. delivers the optimum electrochemical performance, we have performed 4 more set of experiments with different sintering time of 4 h, 8 h, 18 h, and 24 h at 850° C. The resulted electrode cycling performance is shown in Chart C of FIG. 5. Solid-state sintering at 8 h, 12 h and 18 h deliver better cycling performance than at 4 h and 24 h. This can be understood by the following: by sintering for a short time of 4 h, the Li₂CO₃ may not fully react with the degraded cathode material to compensate the Li⁺ loss, which leads to worse cycling stability; if the sintering time is as long as 24 h, there could be severe Li evaporation and particle agglomeration, which deteriorates the electrochemical performance. Overall, the specific capacity and cycling stability of LiCoO₂ regenerated by hydrothermal approach with short annealing is similar to the best sample regenerated by the solid-state approach shown in Chart D of FIG. 5, while the former process is much easier to operate and scale up.

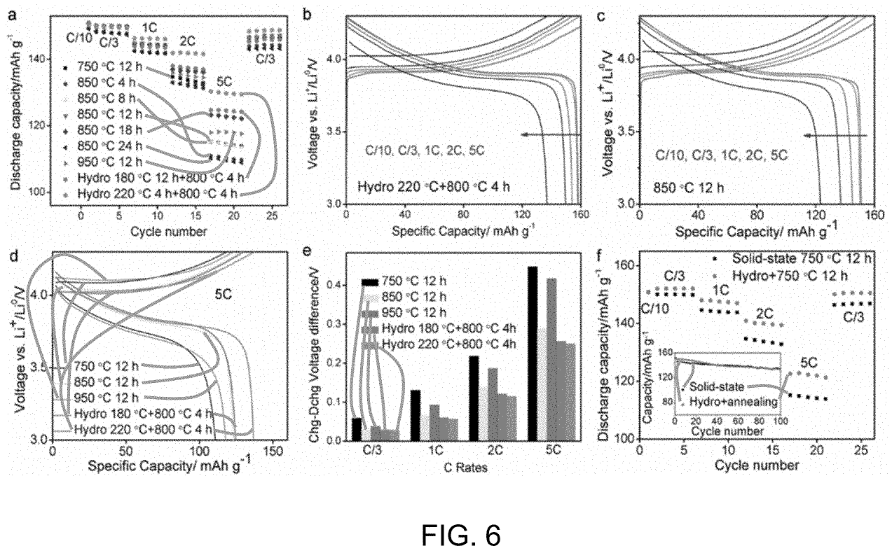

More interesting results were found in the evaluation of rate capability. The regenerated LiCoO₂ materials with similar cycling stability show different rate performance in Chart A of FIG. 6. The LiCoO₂ cathodes regenerated by two hydrothermal treatment conditions with short annealing have the best rate capabilities, while the sample treated at 220° C. for 4 h performs better. For the solid-state synthesis approach, the cathodes regenerated at 850° C. for 8 h, 12 h and 18 h show similar cycling performance to that which was illustrated in Chart C of FIG. 5, while different rate performance. The sample sintered for 8 h has worse rate capability than the samples sintered for 12 h and 18 h, and the latter two samples show similar rate capability. Therefore, the optimum condition to regenerate cycled cathode material through solid-state approach is identified as 850° C. for 12 h. Compared with the best rate capability in the solid-state approach, the hydrothermal treatment with annealing approach delivers much better rate performance. The cathode treated at 180° C. for 12 h has a discharge capacity of 138.0 mAh g⁻¹ at 2C and 124.7 mAh g⁻¹ at 5C, and the cathode treated at 220° C. for 4 h has higher discharge capacity of 141.9 mAh g⁻¹ at 2C and 130.3 mAh g⁻¹ at 5C. Charts B and C in FIG. 6 demonstrate the voltage-capacity profiles of LiCoO₂ regenerated through hydrothermal approach at 220° C. and solid-state synthesis at 850° C. The hydrothermal sample has smaller voltage drops at the beginning of each discharging, which indicates a smaller polarization. For a clearer comparison, the voltage-capacity profiles at 5C for all the samples are plotted in Chart D of FIG. 6, and the hydrothermal sample shows the highest discharge plateau. To quantify the polarization, Chart E of FIG. 6 displays the differences between the average charge and discharge voltages of all the samples, in which a larger difference means larger polarization due to lower electronic and Li⁺ conductivity. For a direct comparison between the two approaches, LiCoO₂ is also regenerated through hydrothermal treatment followed by annealing at 750° C. for 12 h, and compared with the regenerated sample by solid-state synthesis at 750° C. as shown in Chart F of FIG. 6. By sintering at the same temperature and time, the material generated by hydrothermal approach has similar cycling performance, while much better rate performance than the solid-state approach. The hydrothermal sample has a discharge capacity of 122.6 mAh g⁻¹ at 5C while the solid-state sample only has 115.1 mAh g⁻¹ at 5C.

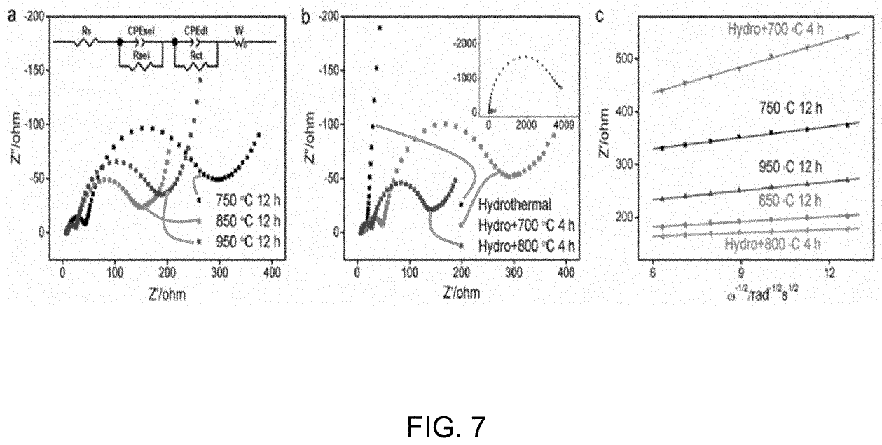

To investigate the mechanism for the different electrochemical performance of LiCoO₂ regenerated under different conditions, EIS measurement was performed on the LiCoO₂ at discharged state after 100 cycles at 1C. Chart A and B of FIG. 7 show the Nyquist plot of regenerated LiCoO₂ cathode through solid-state and hydrothermal approaches, respectively. The inset picture in Chart A displays the equivalent circuit to fit the Nyquist plots and get quantitative value of resistances. Rₛ, Rₛₑᵢ and R_{ct} are the Ohmic resistance (electrolyte contact, electrode), SEI film resistance, and charge-transfer resistance, respectively. W is the Warburg impedance related to the Li⁺ diffusion. Table 3 shows the resistance values according to the fitting results from the equivalent circuit.

TABLE 3
Resistance parameters of equivalent circuits in EIS measurement.

| | Rₛ/Ω | Rₛₑᵢ/Ω | R_{ct}/Ω | D_{Li}⁺/cm²s⁻¹ |
|---|---|---|---|---|
| 750° C. 12 h | 10.21 | 33.16 | 204.7 | 8.01 × 10⁻¹³ |
| 850° C. 12 h | 9.83 | 16.38 | 104.9 | 3.87 × 10⁻¹² |
| 950° C. 12 h | 7.852 | 17.09 | 129.4 | 1.23 × 10⁻¹² |
| Hydrothermal | 7.492 | 7.835 | 3292 | |
| Hydro + 700° C. 4 h | 10.94 | 36.33 | 198.8 | 1.51 × 10⁻¹³ |
| Hydro + 800° C. 4 h | 7.028 | 16.09 | 97.44 | 9.03 × 10⁻¹² |

The LiCoO₂ cathode regenerated by sintering at 850° C. has lower SEI and charge transfer resistances than the cathodes sintered at 750° C. and 950° C. The cathode regenerated by hydrothermal treatment followed by 800° C. annealing has the lowest resistances among all the regenerated cathodes, with a SEI resistance of 16.09Ω and charge transfer resistance of 97.44Ω. The superior rate performance of the hydro 800° C. cathode is attributed to its lowest charge transfer resistance which favors the charge transfer reaction for Li⁺ intercalation.

The linear part of Nyquist plot in the low frequency range is directly related to Li⁺ diffusion in electrode, and Li⁺ diffusion coefficient could be calculated using the following equation.

$$D = \frac{{R}^{2} {T}^{2}}{2 {A}^{2} {n}^{4} {F}^{4} {C}^{2} {σ}^{2}} \qquad ( 4 )$$

R is the gas constant, T is the absolute temperature, A is the interface between cathode and electrolyte (A=1.6 cm²), n is the number of electrons involved in reaction (n=1), F is the Faraday constant, C is the concentration of Li⁺ in the electrode (=ρ/M) based on the molecular weight of LiCoO₂ (M) and density (ρ), and σ is the Warburg factor. The Warburg factor can be obtained from the slope of Z′ vs. ω^{-1/2} plots (ω is the angular frequency) in the Warburg region. The results of the Z′ vs. ω^{-1/2} for regenerated cathodes after 100 cycles, along with the linear fitting curves, are shown in Chart C of FIG. 7. After the slopes are obtained, the Li⁺ diffusion coefficients for all the samples are calculated and shown in Table 3 (above). The hydro-800° C. cathode has the largest Li⁺ diffusion coefficient of 9.03×10⁻¹² cm² s⁻¹, which corresponds well with its smallest polarization shown in Chart E of FIG. 6. Since the post-annealing could increase the crystallinity of cathode, annealing at 800° C. results in a higher crystallinity than at 700° C. (see Chart C of FIG. 3), which favors the Li⁺ diffusion by providing a perfect Li⁺ diffusion path inside the particle. For the solid-state synthesis, 850° C. is determined to be the optimum condition to obtain good diffusion property, which is consistent with literature but it is still inferior to hydrothermal sample after 800° C. annealing.

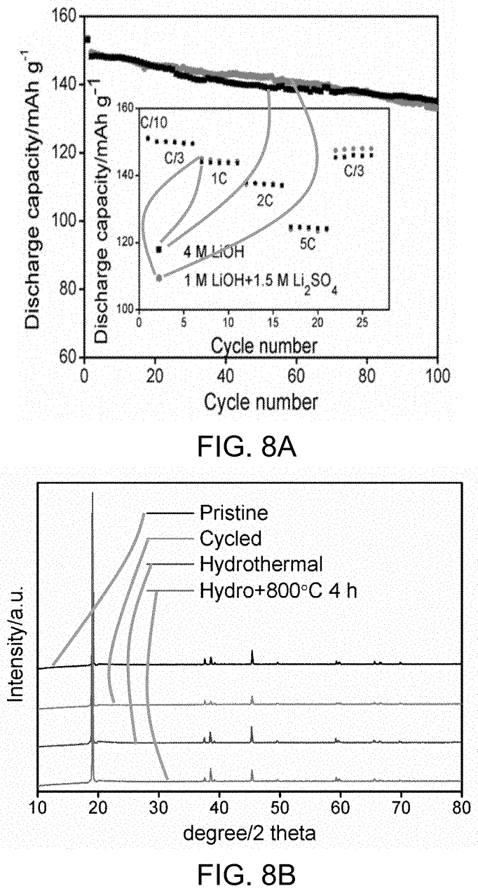

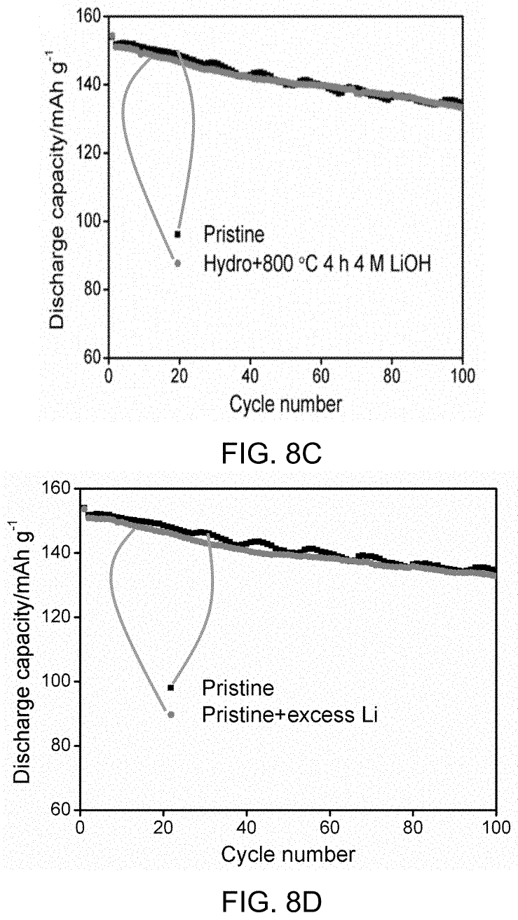

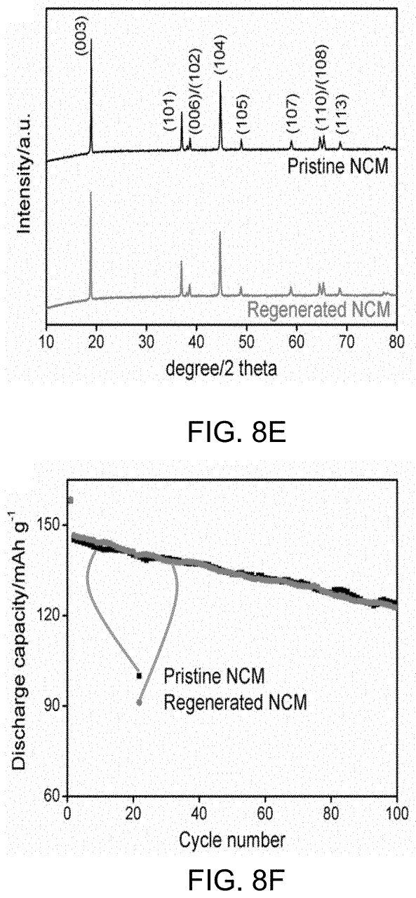

The hydrothermal treatment was first carried out using 4 M LiOH solution with a high pH of 14.6. Developing more environmental benign operation is always desired for large-scale industrial processes. Therefore, we replaced the 4 M LiOH solution with a mixed solution containing 1 M LiOH and 1.5 M Li₂SO₄ to reduce the pH to 12.3. With all the other conditions the same, the cycled LiCoO₂ treated with the mixed Li salt solution shows similar cycling stability and rate performance with the LiCoO₂ treated with 4M LiOH solution, as shown in FIG. 8A. The successful regeneration of LiCoO₂ with mixed Li salt with decreased pH provides more flexibility and reduces the operation cost.

To further verify the effectiveness of this recycling and regeneration approach, the same hydrothermal treatment with short annealing procedure is applied to recycle LiCoO₂ from the home-made cells. To have enough LiCoO₂ cathode material for recycling, thick electrode with a high mass loading of 28 mg/cm² were made. After cycling in the voltage range of 3-4.5 V to gain >50% of capacity fading, the cells were discharged to 2 V at C/10 and disassembled. ICP was performed on the harvested LiCoO₂ and the composition was determined to be Li_{0.59}CoO₂. The Li⁺ loss is higher compared with the commercial cathode cycled after 200 cycles, which is believed to result from the Li⁺ loss in the Li metal anode due to the SEI formation. It should be noted that due to the processing limitation of the lab-scale coin cells, their resistance was higher than the commercial pouch cells. Therefore, Li⁺ may not fully get back to the cathode even though the cell was discharged to 2 V. The LiCoO₂ regeneration was performed by hydrothermal process with 4M LiOH solution followed by short annealing at 800° C. for 4 h. The XRD patterns of cycled and regenerated LiCoO₂ illustrated in FIG. 8B suggest that the regenerated materials have reproduced well-defined layered structure, similar to pristine LiCoO₂ powder. The cycling performance of pristine and regenerated LiCoO₂ are compared below. It is clear that the regenerated LiCoO₂ could fully recover the specific capacity and cycling stability of the pristine sample, as shown in FIG. 8C. The performance is also similar to LiCoO₂ regenerated from cycled commercial pouch cells. This experiment indicates that this method based on hydrothermal treatment with short annealing is effective in regenerating cycled cathodes with various degradation conditions.

Considering mixed cathode chemistry is widely used in LIBs, it is ideal that the recycling approach could regenerate mixed cathode material. Mixed LiCoO₂ (LCO) and NCM cathode is used as the model material to demonstrate the feasibility of this approach to process mixed cathode material. We assembled two types of cells: 1) pure NCM-based pouch cells and 2) pouch cells using LCO−NCM mixed cathode with an active mass ratio of 1:1. After the pouch cells were cycled in the voltage range of 3-4.5 V until the capacity was decayed more than 40%, those pouch cells were disassembled and the cathode material was harvested. To confirm that the NCM cathode material had suffered from Li⁺ loss, ICP measurement was performed on pristine and cycled NCM cathode. The composition of the NCM cathode is changed from Li_{1.005}Ni_{0.331}Co_{0.341}Mn_{0.330}O₂ to Li_{0.796}Ni_{0.326}Co_{0.342}Mn_{0.329}O₂, which means the NCM cathode has about 20% Li⁺ loss after cycling.

Through this further study, one difference we found between NCM and LCO cathode material is their tolerance of underdosing and overdosing of Li. During the short annealing process, the evaporation of Li can lead to a slight underdosing of Li. Under such conditions NCM cathode material has the problem of cation mixing between Li and Ni ions, which means Ni²⁺ might take the place of Li⁺, deteriorating the electrochemical performance. Therefore, although the hydrothermal treatment can result in stoichiometric Li concentration in regenerated NCM cathode, a small amount of excess Li source (e.g. 5% Li₂CO₃) is added to compensate the Li loss for regenerating LCO and NCM mixed cathode material. Considering the optimum temperature for the solid-state reaction to introduce Li was 850° C. according to experimental results, the short annealing temperature was increased from 800° C. to 850° C. for the processing of mixed cathode material. To prove that LiCoO₂ has tolerance for slight overdosing of Li, pristine LiCoO₂ was sintered with a small amount of Li source at 850° C. for 4 h. The cycling performance of the slightly overdosed LiCoO₂ was similar with the pristine material, as illustrated in FIG. 8D. In addition, pure cycled NCM cathode from the home-made pouch was regenerated through hydrothermal treatment at 220° C. for 4 h, followed by short annealing with small amount of excess Li₂CO₃ at 850° C. for 4 h. The XRD patterns of pristine and regenerated NCM powders are shown in FIG. 8E, and the regenerated material has well-defined layered structure, similar to pristine NCM powder. The cycling performance of pristine and regenerated NCM powders is shown in FIG. 8F, and the regeneration process fully recovered the capacity and cycling stability of pristine NCM cathode. Based on the above experimental results, the mixed cathode material was regenerated through hydrothermal treatment at 220° C. for 4 h, followed by short annealing with a small amount of Li sources at 850° C. for 4 h.

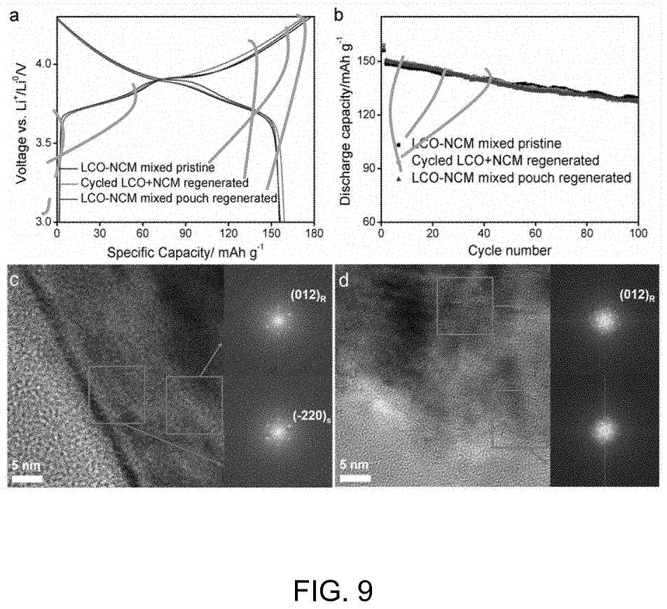

Two batches of cycled mixtures were regenerated by this approach. The first batch was the mixture of degraded cathode materials from cycled LCO pouch cells and cycled self-made NCM pouch cells (denoted as cycled LCO+NCM). The second batch is the degraded cathode material from cycled self-made LCO−NCM mixed pouch cell (denoted as LCO−NCM mixed pouch). The mass ratio between LCO and NCM in these two batches was both 1:1. Pristine mixed LCO and NCM material in a mass ratio of 1:1 serves as the reference for its comparison with the regenerated materials. The voltage-capacity profiles of pristine and regenerated mixed cathode materials illustrated in Chart A of FIG. 9 show two large plateaus at 3.9 V and 3.75 V, agreeing well with the charge/discharge behavior of LCO and NCM, respectively. As shown in Chart B of FIG. 9, the regenerated mixed cathode material could fully recover the original capacity and cycling stability. The initial discharge capacity for the pristine mixed material is 156.1 mAh g⁻¹, and maintains a discharge capacity of 129 mAh g⁻¹ after 100 cycles. After regeneration of the cycled LCO+NCM and LCO−NCM mixed pouch cathodes, their initial discharge capacities are 159 and 156.8 mAh g⁻, with discharge capacities of 128.1 and 127.3 mAh g⁻ in the 100th cycle, respectively. These results suggest the successful regeneration of mixed cathode materials using the aforementioned process. It is known that the phase change in the crystal structure is one important reason for the capacity degradation in NCM cathode. The migration of transition metals to the Li layers leads to phase change from layered to spinel structure. The difficulty to regenerate a NCM cathode is that transition metals and Li need to be re-constructed. To more directly prove that the cycled NCM we obtained is representative of degraded electrode with transition metal/Li disorder, and such disorder can be re-constructed after regeneration, TEM images of the degraded and regenerated electrode particles were taken. More than 20 particles were observed. Image C and D of FIG. 9 show the representative images at the zone axis of [4-21], from which any existing layered, spinel and rock salt structures can be observed. In the cycled electrodes (Image C), the spinel phase was observed at the surface of active particles, evidenced by the existence of (−220) plane, which is the proof of migration of transition metal to the Li layers, consistent with literature report. After regeneration (Image D), no spinel phase can be observed at the surface. Therefore, it is proved that: (1) the sample is representative of degraded electrodes with transition metal/Li disorder; and (2) transition metal and Li are successfully re-constructed after regeneration. More systematic research can be performed in the future to further investigate the influence of different recycling conditions on the electrochemical performance of regenerated mixed cathode material. Nevertheless, this set of experiments is a strong demonstration of the feasibility of this approach on processing mixed cathode materials. The phase change in the crystal structure is one important reason for the capacity degradation in LiCoO₂ and NCM cathode materials.

Overall, this cathode regeneration strategy offers significant advantages. The common acid leaching approach requires the usage of corrosive acids, as well as complicated neutralization and precipitation steps to recover metals and reduce waste, while the solid-state synthesis requires chemical analysis and accurate control of Li⁺ dosage which makes large-scale operation difficult. Compared with both approaches, the hydrothermal approach with short annealing requires neither complicated chemical processing nor tedious elemental analysis to determine the Li⁺ loss, and can readily process batteries with different conditions of capacity degradation. The alkaline solution after processing cathode material can be reused, since the hydrothermal process will only slightly change the concentration of Li⁺ in the solution. Considering that the solid particles can be easily separated from the solution, we could recycle and reuse the alkaline solution after processing a batch of cathode material. Extra LiOH can be added to the used alkaline solution to compensate the decreased LiOH concentration, and the adjustment could be easily done by measuring the pH value of the alkaline solution. In addition, only a short period of annealing step is needed, rather than the long-time sintering required in solid-state synthesis approach to allow slow solid-state diffusion. Therefore, the hydrothermal approach both increases the ease of operation and decreases the energy cost for processing.

Besides the NMP dissolution approach used in this study to separate active materials, there are other solvents for PVDF to replace the toxic NMP, such as acetone. In addition, the dissolution process is not the only way to separate active materials, binder and conductive additives. Thermal treatment, for example, could be another choice to separate different components in electrodes. Researchers have successfully used thermal treatment to liberate the electrode particles from the current collectors by a vibrating screening, which can be easily performed in large-scale industry process. The details on the separation methods are not further discussed because the focus of the current study is the regeneration of the active material, rather than the separation of different components in electrodes.

To further understand the energy efficiency of this approach, we have compared the energy consumption of this process with the solid-state synthesis approach. Due to the complexity of the energy consumption calculation regarding various instrument and operation efficiency, we simplified the calculation by considering only the energy consumption required to heat the material and keep it at the desired temperature. According to the equation:

$$Q = {\int }_{0}^{t} [ m {C}_{P} \frac{dT}{dt} + A h ( T - {T}_{a m b} ) ] d t \qquad ( 5 )$$

in which Q as the required energy, t as time, m as mass, Cₚ as the specific heat capacity, A as the surface area exposed to air, h as the convective heat transfer coefficient, T as the temperature of the material, T_{amb} as the ambient temperature, we can calculate the energy needed for both processes. The parameter values for the calculation are listed in Table 4.

TABLE 4
Parameter values for energy consumption calculation

| C_{P} of LiCoO₂ | C_{P} of LiOH | C_{P} of Water | h | T_{amb} |
|---|---|---|---|---|
| 71.62 J | 49.58 J | 75.3 J | 12 W | 298K |
| mol⁻¹ K⁻¹ | mol⁻¹ K⁻¹ | mol⁻¹ K⁻¹ | m⁻² K⁻¹ | |

We take the volume ratio between solid material (cathode particles) and water in hydrothermal reactor as 1:1, which is easily achievable in this solid-liquid two phase reaction. Considering the processing of 1 kg LiCoO₂, A for the mixture of LiCoO₂ and LiOH solution is assumed to be 0.033 m², and A for the pure LiCoO₂ powder is assumed to be 0.021 m², based on the tap density of 3.5 g/cm² for LiCoO₂. For hydrothermal plus short annealing approach, the energy consumption to heat 1 kg LiCoO₂ together with LiOH solution to 220° C. and keep 4 h is calculated to be 1589.4 kJ, and to heat LiCoO₂ to 800° C. and keep 4 h is calculated to be 4287.5 kJ. The total energy consumption is 5876.9 kJ. For solid-state synthesis, the energy consumption to heat 1 kg LiCoO₂ to 850° C. and keep 12 h is calculated to be 10614.1 kJ. Therefore, the energy consumption of hydrothermal treatment is much less than that of the solid-state synthesis, which means the hydrothermal plus short annealing approach is more energy efficient than the solid-state synthesis approach.

In terms of electrochemical performance, the regenerated active particles from this process can achieve better rate capability than those regenerated through the best condition in solid-state synthesis while offer similarly high capacity and cycling stability. Furthermore, the hydrothermal approach can be used to regenerate mixed cathode materials, which makes it more attractive, considering mixed cathode chemistry is more likely to be used in the LIB industry. Therefore, compared with the state-of-the-art approaches, this work provides a promising strategy to regenerate spent LiCoO₂ cathodes with easy processing and low energy consumption without generating additional wastes.

C. Conclusions

In summary, a simple yet efficient non-destructive approach is disclosed to recycle and regenerate LiCoO₂ particles from spent LIBs by combining hydrothermal treatment and short annealing. This approach could fully recover the specific capacity and cycling stability of LiCoO₂ without changing the original morphology and size distribution. Compared with the solid-state synthesis approach, the LiCoO₂ particles regenerated through hydrothermal approach show improved rate capability, which are attributed to the smaller charge transfer resistance and larger Li⁺ diffusion coefficient. This strategy represents a simple and energy efficient approach to regenerate spent LiCoO₂ cathodes with high electrochemical performance, and can be applied on industrial-scale operation. We expect this strategy can be also applied to other types of cathodes in LIBs, such as LiMn₂O₄, LiFePO₄ and LiₓNi_{y}Mn_{z}Co_{1-y-z}O₂ (0<x,y,z<1).

II. Resolving Defects in Degraded NCM Particles

The aforementioned work on combining hydrothermal treatment with short thermal annealing to regenerate degraded LiCoO₂ (LCO) particles has demonstrated the successful reconstruction of stoichiometry composition and desired crystalline structure from severely degraded LCO cathode materials. However, the cathode reactivity and stability may change dramatically with their original composition and crystal structure. The complex chemistry in layered oxide LiNiₓCo_{y}Mn_{z}O₂ (NCM) cathodes can influence the change of crystal structure and local phase after cycling, which further affects the regeneration process. Accordingly, challenges may arise from the different degradation mechanisms of NCM cathode materials compared with simple LCO. More specifically, besides the Li⁺ loss due to the thickening of solid electrolyte interface (SEI), the crystal structure and microphase change on the particle surface (or sub-surface) is a major reason for the capacity degradation in layered oxide cathodes. For LCO, spinel phases such as Co₃O₄ and LiCo₂O₄ can form after degradation, while in the case of NCM, the phase change is more complicated. Due to the Li⁺ deficiency and migration of Ni2⁺ between the layers, the rock salt phase (e.g., NiO) will form at the surface besides the common spinel phase. Both phases increase the charge-transfer resistance and reduce the cathode performance. However, reconstructing rock salt phase into Li⁺ conducting layered structure is challenging due to the thermodynamically unfavorable nature of this reaction.

Despite these challenges, a particle-to-particle approach was developed for successful regeneration of degraded NCM cathodes. Using non-destructive methods, nearly ideal stoichiometry, low cation mixing and high phase purity were achieved in the regenerated NCM particles, which offer high specific capacity, cycling stability and rate capability reaching pristine materials. This work represents a simple yet efficient approach to directly regenerate high-performance NCM cathodes with distinct advantages over traditional hydrometallurgical methods and builds an important foundation for the sustainable manufacturing of energy materials.

The effort focuses on developing non-destructive approaches to directly regenerate degraded NCM cathode particles by resolving their compositional and structural defects. Specifically, a hydrothermal treatment combined with a short annealing was used in controlled atmospheres to regenerate NCM cathode particles. As a comparison, direct solid-state sintering approach was also examined to understand the activity of degraded NCM particles. The reaction mechanism was carefully investigated during different cathode regeneration processes. LiNi_{1/3}Co_{1/3}Mn_{1/3}O₂ (NCM111) and LiNi_{0.5}Co_{0.2}Mn_{0.3}O₂ (NCM523) cathodes were selected as the model materials to study the effect of nickel content on the evolution of particle stoichiometry and microphase. With optimized conditions, both spinel and rock salt phases can be fully converted back to layered phase using these direct regeneration approaches, as confirmed by systematic physicochemical characterizations. The lithium storage capacity and cycling stability of the degraded NCM111 and NCM523 cathode particles can be also recovered to the original levels of the pristine materials.

A. Experimental

Pouch cells assembly and cathode materials harvesting: Dry pouch cells (220 mAh) with NCM523 as the cathode and graphite as the anode were directly purchased from Li-Fun Technology (Xinma Industry Zone, Golden Dragon Road, Tianyuan District, Zhuzhou City, Hunan Province, PRC, 412000). Electrolyte was filled in and the pouch cell was sealed by the vacuum sealer (MTI corporation). The electrolyte (LP40) was 1M LiPF6 in ethylene carbonate (EC) and diethyl carbonate (DEC) with a weight ratio of 1:1. After formation at C/10 (C=150 mA g−1) for the first cycle, the pouch cells were cycled in the voltage range of 3-4.5 V at 1C for 200 cycles. Commercial LCO pouch cells were purchased from MTI Corporation (2000 mAh, EQ-PL-605060-2C). NCM111 pouch cells were assembled as described in previous research, with Li metal foil as the anode and a typical electrode area of 20 mm×55 mm. The NCM111 powder was obtained from Toda America. LCO and NCM111 pouch cells were also cycled in the voltage range of 3-4.5 V to gain >20% capacity loss. All pouch cells were discharged to 2 V before disassembly.

The cathode strips were harvested from the pouch cell, thoroughly rinsed by dimethyl carbonate and soaked in NMP followed by sonication. The active materials, binder and carbon black were removed from the aluminum substrate. The suspension is centrifuged and the active materials were precipitated. The precipitation was washed several times and the active materials were harvested and dried.

Regeneration of cathode materials: The composition of cycled cathode was measured by an Inductively Coupled Plasma Optical Emission Spectrometer (ICP-OES, Perkin Elmer Optima 3000 DV). For hydrothermal treatment, cycled cathode materials were added in a 100 mL Teflon liner of an autoclave filled with 80 mL of 4 M lithium hydroxide (LiOH) solution. In some embodiments, a lithium containing solution can be made by a small concentration (e.g., 0.1M) of lithium salt (e.g., LiOH, Li₂SO₄, LiCl, LiNO₃) with an alkaline solution from NaOH, KOH, NH₄OH or their mixture. The autoclave was heated at different periods of time and temperatures. The treated powders were washed with deionized water and sintered with 5% excess amount of Li source (Li₂CO₃) in oxygen at 850° C. for 4 h with a ramping rate of 5° C./min. 5% excess amount of Li was added to compensate the Li evaporation during the sintering process. For solid-state sintering, the cathode powders were mixed with Li₂CO₃ with agate mortar and pestle. The amount of Li₂CO₃ was calculated to make the mixture with a Li/Co ratio of 1.05. The mixtures were sintered at 850° C. for 12 h with a ramping rate of 5° C./min. The sintering process was performed in air and oxygen atmosphere, respectively.

Characterization of regenerated materials: The morphology of the powders was observed by Ultra High Resolution Scanning Electron Microscope (UHR SEM, FEI XL30). The particle size distribution was analyzed with Nano Measurer software. The crystal structure of the powders was examined by X-ray Powder Diffraction (XRD) employing Cu Kα radiation. The crystal structure was also examined by Transmission Electron Microscopy (TEM) (FEI Titan 80-300 kV S/TEM). The XPS measurement was performed with Kratos AXIS Ultra DLD with Al Kα radiation.

Electrochemical characterization: The pristine, cycled and regenerated cathode materials were mixed with PVDF, and Super P65 in NMP at a mass ratio of 8:1:1. Then the slurries were cast on aluminum foil using a doctor blade and dried in vacuum at 80° C. for 6 h. Circle electrodes were cut and compressed by rolling mill. The active mass loading was about 3 mg/cm². Type-2016 coin cells were assembled with Li metal disc (thickness 1.1 mm) as the anode, 1 M LiPF₆ in EC: DEC (1:1 wt) as the electrolyte, and trilayer membrane (Celgard 2320) as the separator. Galvanostatic charge-discharge was carried out using a LAND battery testing system in the potential range of 3-4.3 V at 1C after C/10 in the initial cycle. The electrochemical impedance spectroscopy (EIS) tests were carried out at discharged state in the frequency range of 106 Hz to 10-2 Hz with a signal amplitude of 10 mV by Metrohm Autolab Potentiostats.

B. Results and Discussion

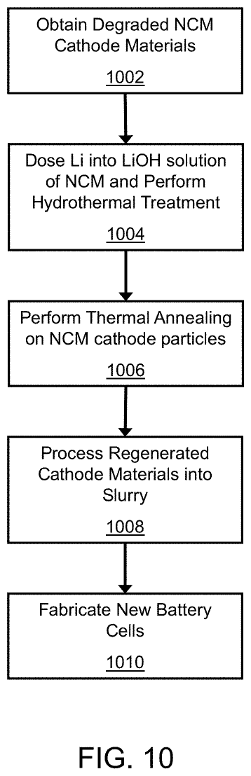

FIG. 10 illustrates an exemplary method of illustrates an exemplary method of regenerating degraded NCM cathode materials using a particle-to-particle approach. In step 1002, the degraded or cycled NCM cathode materials are obtained, and in step 1004, lithium (Li) is pre-dosed into the Li-deficient NCM cathode particles and the NCM cathode particles are treated with a hydrothermal treatment, after which a short thermal annealing is performed in step 1006. Once the NCM cathode particles have been regenerated, in step 1008, the particles may then be processed into a slurry which, in step 1010, can be fabricated into new battery cells.

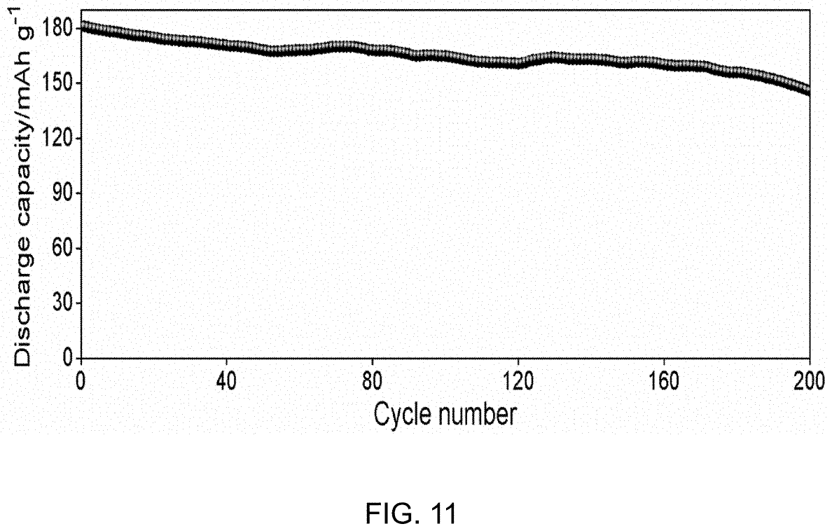

Both commercial and home-made cells were used for the demonstration and performance evaluation. The cell assembly and the materials harvesting for LCO and NCM111 pouch cells followed standard procedures. The assembly of NCM523 pouch cells are described in the Experimental section above, with the same materials harvesting procedures as LCO and NCM111 pouch cells. All pouch cells were cycled in the voltage range of 3-4.5 V at 1C with capacity degradation of more than 20% over approximately 200 cycles, as shown by the graph of cycling performance of the NCM523 pouch cell in FIG. 11. The cell was cycled in the voltage range of 3-4.5 V at 1C (C=150 mA g⁻¹). The capacity degradation is 22% after 200 cycles.

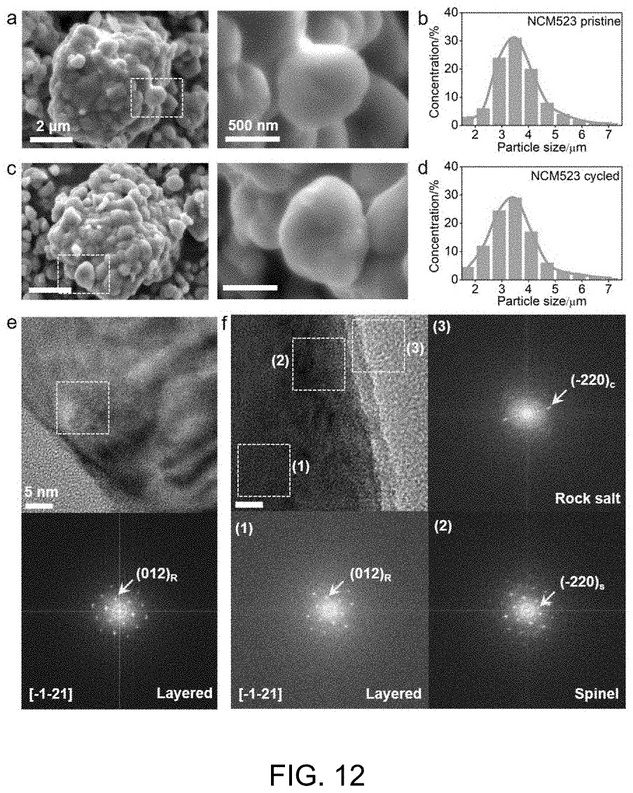

The degraded cathode particles were obtained and subject to hydrothermal treatment with a short thermal annealing step (denoted as HT-SA), or to a direct solid-state sintering treatment by mixing with Li salt (denoted as SS). The regenerated cathode materials were made into slurries to fabricate new coin cells to evaluate their electrochemical performance for the sake of convenience and consistence, as described in the Experimental section. The scanning electron microscopic (SEM) images of pristine NCM523 particles are shown in Panel (a) of FIG. 12, with the size distribution of the pristine NCM523 particles displayed in Panel (b). SEM images of cycled (degraded) NCM523 particles are shown in Panel (c) of FIG. 12, with the size distribution of the cycled NCM523 particles displayed in Panel (d). The left images of the two SEM images in Panels (a) and (c) show secondary particles, while the right images show primary particles.

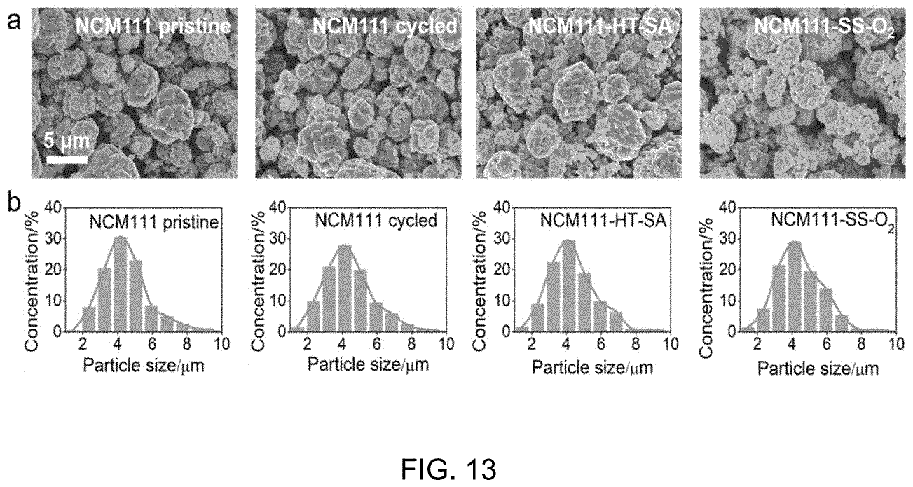

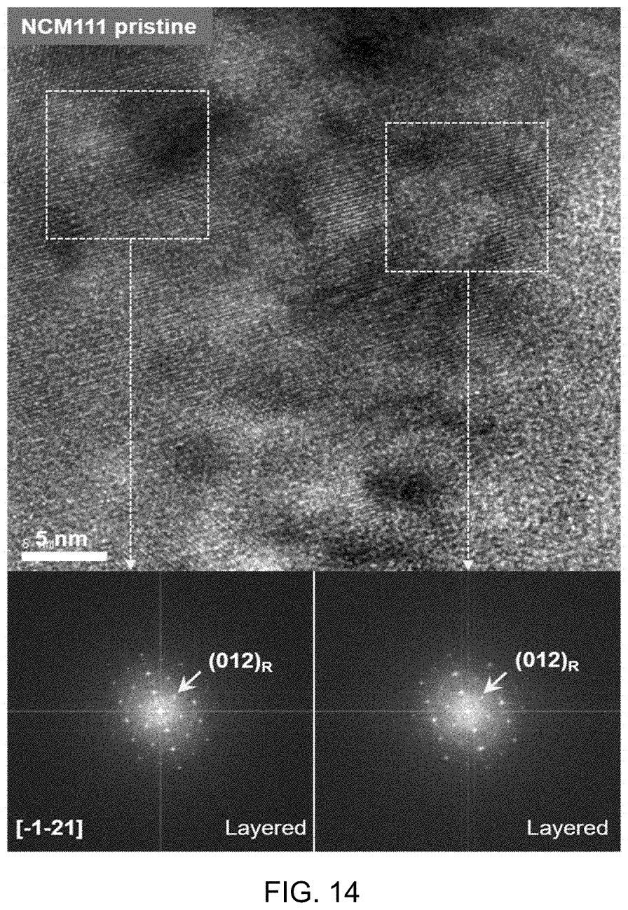

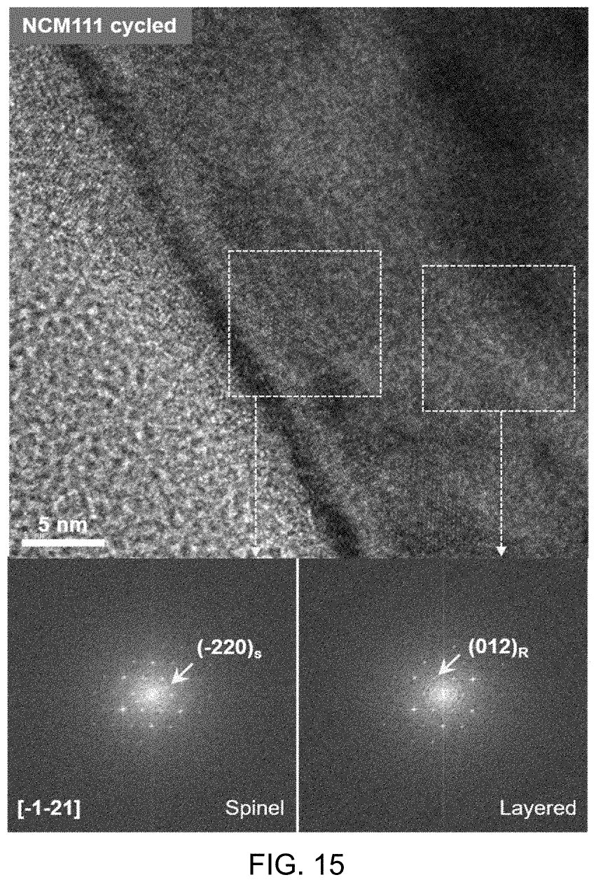

The particle morphology and size distribution of NCM111 samples were also monitored, as illustrated in FIG. 13. Panel (a) shows SEM images of the samples, while the corresponding Panel (b) illustrates size distributions of the NCM111 particles. All the particles have similar morphology and sizes, in which the sizes of the secondary particles mainly distribute in approximately 3-5 micrometers (μm), with primary grains of approximately 0.2-1.0 μm in diameter. The spherical secondary particle was maintained after cycling. Since the micro-phase change is one of the most important reasons for the cathode degradation, high resolution transmission electron microscopic (HR-TEM) images were taken to directly observe the changes in crystal structure after cycling. More than 20 particles were examined for each sample. As expected, the pristine NCM 111 cathodes shown in the HR-TEM and Fast Fourier Transform (FFT) images taken along the [4-21] zone axis shown in FIG. 14. The pristine NCM523 cathodes shown in the HR-TEM image and FFT image of Panel (e) in FIG. 12 only show layered rhombohedral structure, with hexagonal diffraction pattern showing (012) plane. As shown in FIG. 15, the cycled NCM111 particles have layered phase in the bulk region and show spinel phase near the surface, as shown in the HR-TEM and FFT images of cycled NCM111 along the [4-21] zone axis. Diffraction spots from the spinel phase were detected along with the layered phase, with the additional diffraction spots indexed as (−220)ₛ. Similarly, diffraction spots from the spinel phase were also observed in cycled (degraded) NCM523 shown by the HR-TEM and FFT images in Panel (f) of FIG. 12, demonstrating co-existence of layered, spinel and rock salt phases. Besides the spinel phase, the rock salt phase appears in the region of ˜3 nanometers (nm) from the surface of the NCM523 particles, with a reduction in the number of diffraction spots due to the high symmetry of rock salt phase, and the diffraction spots are indexed as (−220)_{c}. No rock salt phase was clearly detected in cycled NCM111 cathode in this case. The phase transformation in the surface region could be due to the Li⁺ deficiency near the surface, which is generally observed in layered cathode material because it is a thermodynamically favored transformation when the Li contents are reduced to half of that in the original structure.

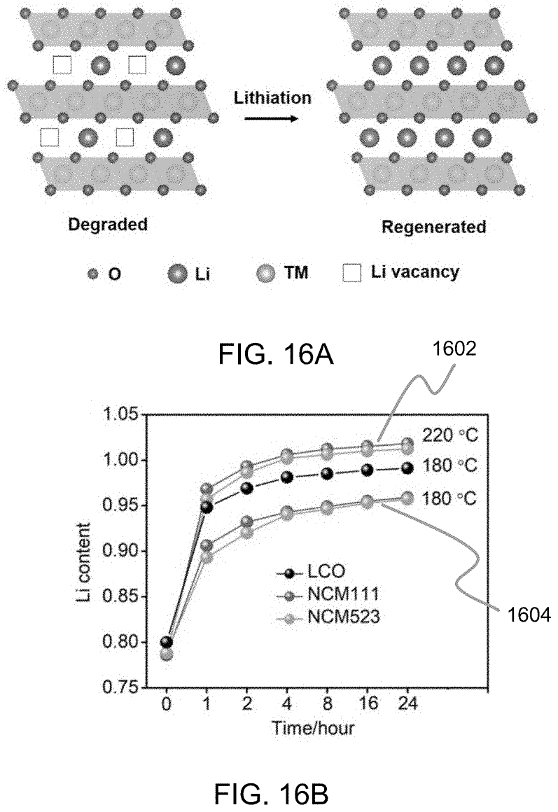

With the above understanding, the first step to regenerate the degraded cathode particles is to re-dose lithium using a hydrothermal-based solution impregnation method. FIG. 16A illustrates the lithiation process of various cathode particles during the hydrothermal treatment, in which Li⁺ are re-dosed to the Li-deficient sites to recover its desired stoichiometry. Interestingly, significant differences were found for different cathode chemistries, as illustrated in FIG. 16B by the lithiation kinetics of degraded LIB cathode particles during hydrothermal treatment. The Li⁺ concentration of different cathode particles changed dramatically with hydrothermal treatment temperature and time. For degraded LCO particles (Li_{0.8}CoO₂) 1602, the Li concentration can be recovered to 0.98 after being treated at 180 degrees Celsius (° C.) for 4 hours (h), which is not the perfect stoichiometry, but common for LCO even in the pristine particles. However, for degraded NCM111 and NCM523 particles 1604, the Li stoichiometry cannot be fully recovered (e.g., only 0.95) after being treated at 180° C. for even 24 h. Nevertheless, once the temperature increases to approximately 220° C., the Li concentration can be fully recovered after a treatment of only 4 h. The different lithiation kinetics of NCM and LCO may be related to the higher degree of cation mixing in NCM due to the similar sizes of Ni²⁺ (0.69 Angstroms (Å)) and Li⁺ (0.72 Å). Since Ni²⁺ ions occupy Li⁺ sites, the activation energy barrier is higher for the diffusion of Li⁺ because of the smaller separations between the transition metal layers. For the purpose of demonstration, hydrothermal treatment at 220° C. for 4 h was selected to lithiate the degraded NCM111 and NCM523 electrode particles for annealing in the next step.

The compositions of different pristine, degraded and regenerated NCM cathode materials are listed in Table 5. Compared with their pristine composition, both NCM111 and NCM523 particles had about 22% of Li loss after cycling. With the hydrothermal treatment, these degraded particles can be reconstituted with Li to reach the ideal stoichiometry (˜1.0 Li). A following thermal annealing step needs to be performed to reconstruct their desired microphase and crystallinity and maintain the Li concentration in the particles during the thermal treatment.

TABLE 5
Inductively-Coupled Plasma (ICP) results of
pristine and regenerated cathode materials

| Sample | NCM111 | NCM523 |
|---|---|---|
| Pristine | Li_{0.995}Ni_{0.331}Co_{0.341} | Li_{1.009}Ni_{0.492}Co_{0.209} |
| | Mn_{0.329}O_{2.012} | Mn_{0.305}O_{2.015} |
| Cycled | Li_{0.786}Ni_{0.328}Co_{0.340} | Li_{0.788}Ni_{0.490}Co_{0.208} |
| | Mn_{0.325}O_{1.996} | Mn_{0.302}O_{1.985} |
| HT only | Li_{1.012}Ni_{0.329}Co_{0.341} | Li_{1.006}Ni_{0.491}Co_{0.209} |
| | Mn_{0.326}O_{2.009} | Mn_{0.304}O_{2.012} |
| SS-air | Li_{1.016}Ni_{0.331}Co_{0.340} | Li_{1.017}Ni_{0.490}Co_{0.207} |
| | Mn_{0.325}O_{2.010} | Mn_{0.304}O_{2.014} |
| SS-oxygen | Li_{1.016}Ni_{0.331}Co_{0.341} | Li_{1.018}Ni_{0.491}Co_{0.208} |
| | Mn_{0.326}O_{2.012} | Mn_{0.304}O_{2.013} |
| HT-SA | Li_{1.019}Ni_{0.330}Co_{0.340} | Li_{1.021}Ni_{0.490}Co_{0.209} |
| | Mn_{0.327}O_{2.011} | Mn_{0.303}O_{2.013} |

In the LCO cathode, only spinel phases (Co₃O₄ and LiCo₂O₄) are formed after cycling, while in the cycled NCM cathodes, nanoscale domains of rock salt phase often exist besides the spinel phases. To convert the local rock salt MO (M=Ni, Co, Mn) domains back to layered LiMO₂, the following reaction should occur:

MO+0.5Li₂CO₃+0.25O₂↔LiMO₂+0.5CO₂ (6)

This reaction indicates that oxygen partial pressure may be an important factor for the conversion process. Therefore, for comparison, the degraded NCM111 and NCM523 particles were mixed with pre-determined amount of Li⁺ salts to perform direct sintering to reach a target mole ratio between Li and transition metal ions (1.05:1) in both air and oxygen atmosphere. As shown in Table 5, both of the particles can reach desired overall compositions, indicating their non-sensitivity to O₂ partial pressure.

For the HT particles, a short annealing treatment at 850° C. for 4 h was performed in O₂ to reconstruct the desired crystallinity of the material. Also, considering the possible Li loss during the annealing which can lead to cation mixing, a small amount of excess Li was added to compensate such a Li loss. Similarly, the particles with this short annealing treatment also reached the target stoichiometry.

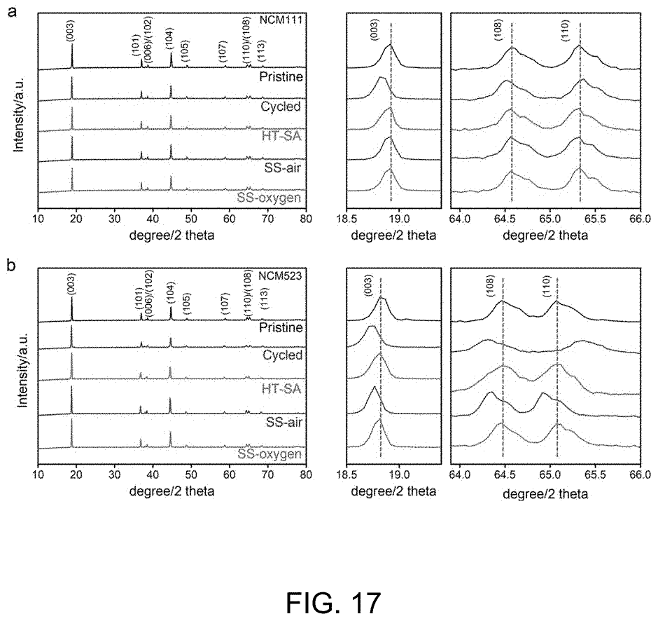

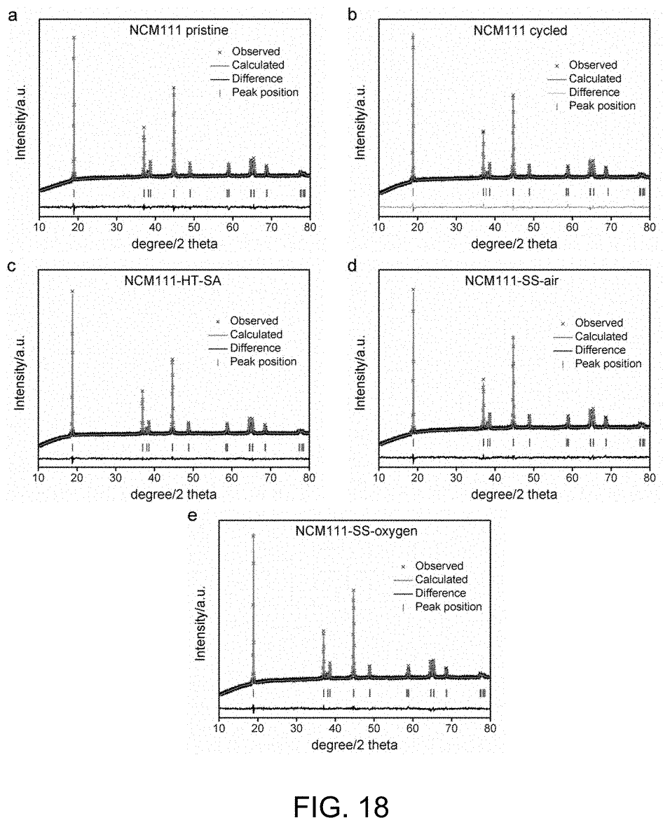

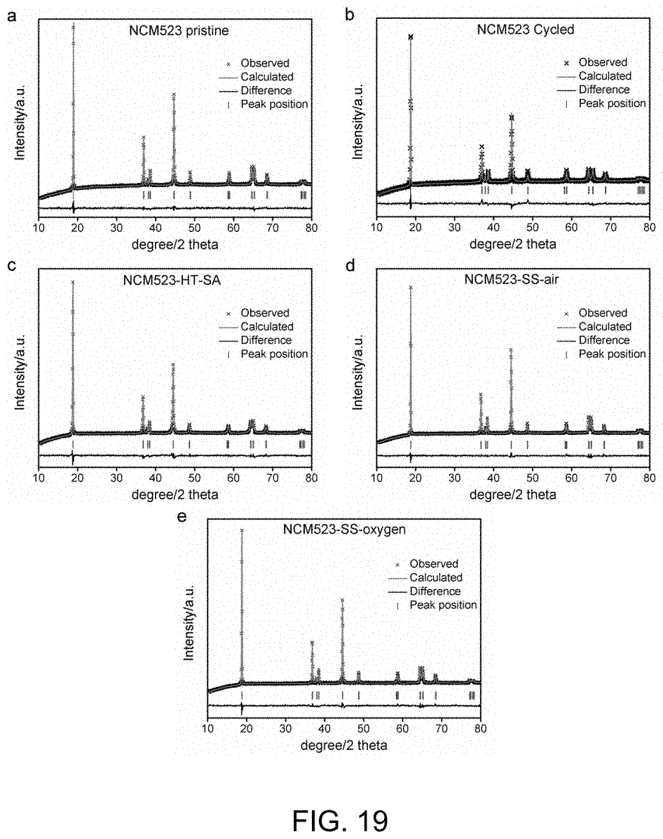

It is also critical to investigate the evolution of the microstructure defects. FIG. 17 illustrates X-Ray Diffraction (XRD) patterns of pristine, cycled and regenerated cathode particles, with Panel (a) showing NCM111 particles and Panel (b) showing NCM523 particles by HT-SA, SS-air and SS-oxygen approaches; the insets at right show enlargement of the regions in the range of approximately 18.5-19.5° and approximately 64-66° . For both NCM111 and NCM523, the cycled cathode particles show a larger intensity ratio of I₀₀₃/I₁₀₄, suggesting higher cation mixing, which is consistent with the previous report. The (003) peak shifts to lower angles, corresponding to an increase in c lattice parameter due to the electrostatic repulsion between the oxygen layers along c directions in the Li deficiency state. The spacing between the peaks in the (108)/(110) doublets increases after cycling, corresponding to the decrease in a lattice parameters due to the smaller effective ionic radii of Ni³⁺ than Ni²⁺ to compensate Li deficiency. After different regeneration processes, the (003) peak shifts back towards higher angles and the spacing between two doublets peaks decreases, which indicates the recovery of the pristine crystal structure. Rietveld refinement was performed on all the XRD patterns (FIG. 18 and FIG. 19), and the lattice parameters are compared in Table 6. FIG. 18 illustrates Rietveld refinement of the XRD patterns of pristine, cycled and regenerated NCM111 cathodes, while FIG. 19 illustrates Rietveld refinement of the XRD patterns of pristine, cycled and regenerated NCM523 cathodes. The refinement results further confirm that the degraded particles have a decreased a lattice parameter and increased c lattice parameters, clearly showing increased Li/Ni cation mixing.

TABLE 6
Lattice parameters for pristine, cycled and regenerated cathode particles

| | | | Li/Ni | | |
|---|---|---|---|---|---|
| Sample | a/Å | c/Å | mixing | R_{B} | R_{wp} |
| NCM111 pristine | 2.8631(7) | 14.248(3) | 2.42% | 5.92% | 1.47% |
| NCM111 cycled | 2.8600(4) | 14.258(4) | 2.81% | 4.9% | 1.52% |
| NCM111-HT-SA | 2.8629(4) | 14.246(2) | 2.07% | 4.22% | 1.43% |
| NCM111-SS-air | 2.8628(6) | 14.250(2) | 2.45% | 5.61% | 1.58% |
| NCM111-SS-oxygen | 2.8624(7) | 14.244(7) | 2.43% | 6.14% | 1.51% |
| NCM523 pristine | 2.8689(4) | 14.240(6) | 3.39% | 4.41% | 1.65% |
| NCM523 cycled | 2.8591(0) | 14.319(2) | 5.10% | 4.92% | 2.53% |
| NCM523-HT-SA | 2.8703(8) | 14.249(5) | 3.74% | 4.99% | 2.17% |
| NCM523-SS-air | 2.8729(9) | 14.255(9) | 5.53% | 3.93% | 1.71% |
| NCM523-SS-oxygen | 2.8682(9) | 14.244(8) | 4.28% | 4.96% | 1.75% |

For all regeneration conditions, the a and c lattice parameters change to higher and lower values, respectively. By comparing HT-SA and SS approaches, it shows that the I₀₀₃/I₁₀₄ intensity ratio of the particles regenerated by the former approach is higher than the latter. This indicates smaller Li/Ni cation mixing of the material regenerated by the HT-SA, which is further confirmed by the refinement results in Table 6. It is also noted that the cation mixing of the NCM111-SS-air sample is similar with that of the NCM111-SS-oxygen sample, while the cation mixing of NCM523-SS-air is larger than that of NCM523-SS-oxygen. Since a high nickel content is considered the key factor for the formation of the rock salt phase, it is speculated that the rock salt phase tends to form more easily in cycled NCM523 cathode than that in cycled NCM111 cathode. As oxygen atmosphere is a critical factor that turns the rock salt phase into the layered phase, the added Li source may not effectively react with the rock salt phase when the oxygen partial pressure is low, and the migration of Ni²⁺ to Li⁺ sites continues to happen in a Li⁺ deficient state, which leads to higher cation mixing degree in the NCM523-SS-air. Overall, the HT-SA samples show much smaller Li/Ni mixing, suggesting its advantage of offering a more homogenous lithiation and more effective phase conversion for particle regeneration.

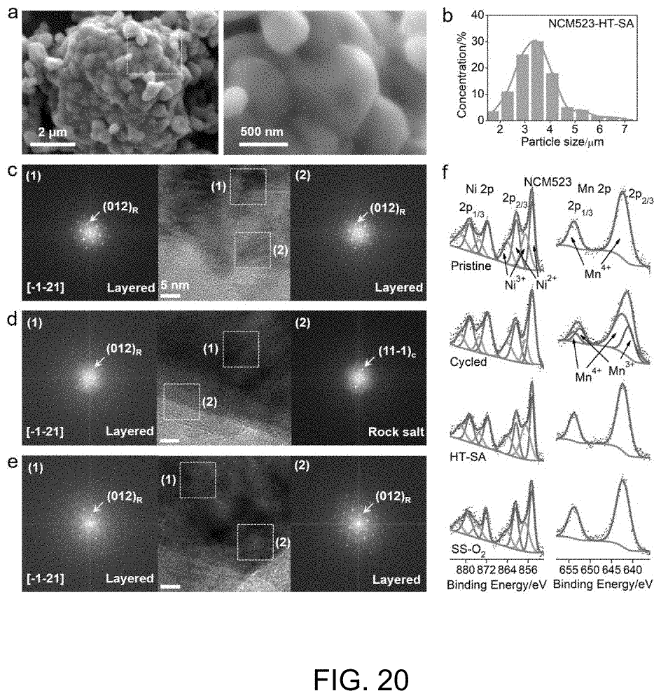

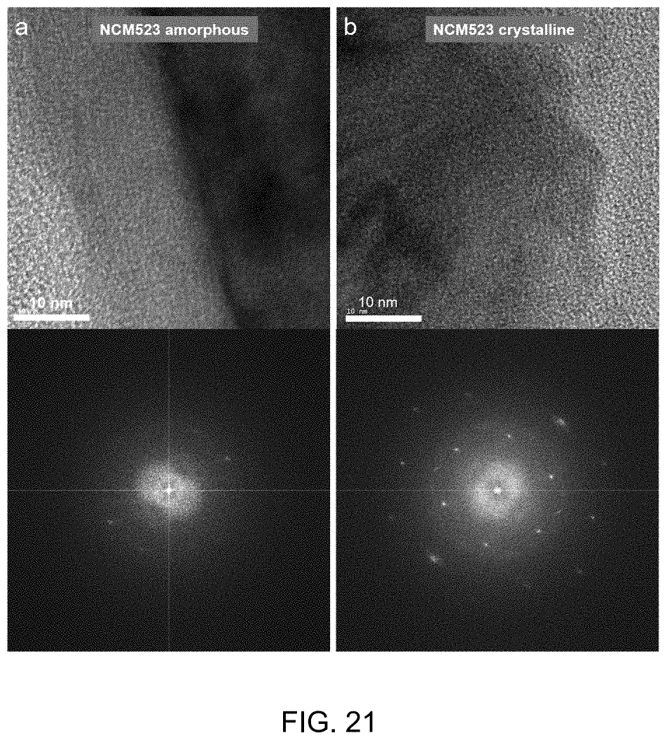

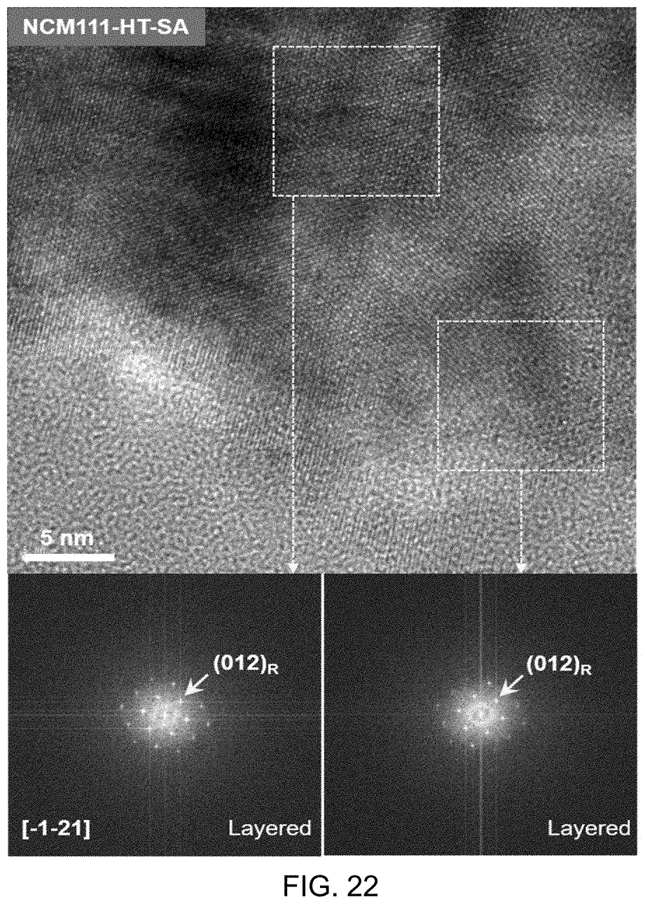

Even though no obvious changes in the morphology and particle size distribution are observed after direct regeneration—as shown in FIG. 20 (and previously in FIG. 13) by the representative SEM images of NCM523-HT-SA particles in Panel (a) and corresponding size distribution graph in Panel (b), their microstructure needs further examination. To prove that the surface phase change can be recovered, the regenerated cathodes were carefully examined by HR-TEM, as shown in Panels (c), (d) and (e) of FIG. 20. The influence of short annealing after the hydrothermal step was investigated by comparing the images of NCM523-HT and NCM523-HT-SA samples. For NCM523-HT, there remain some amorphous domains on the surface, as shown by the HR-TEM and FFT images of NCM523 in Panel (a) of FIG. 21, but the NCM523-HT-SA sample in Panel (b) of FIG. 21 shows a high degree of crystallinity at the surface for each observed particle. Among the 24 particles that were observed, 7 of them show amorphous phase in the region ˜20 nm from the surface. For NCM111-HT-SA and NCM523-HT-SA samples (as shown in HR-TEM and FFT images in FIG. 22 and Panel (c) of FIG. 20, respectively), only layered phase in both the bulk and the surface regions was observed. Both the bulk and the surface show layered rhombohedral structure with diffraction pattern showing (012) plane. For example, in the zone axis of [-1-21], only layered phase exists with the diffraction spot indexed as (012). This indicates that both the spinel and rock salt phases can be effectively converted back to the layered phase by the HT-SA approach.

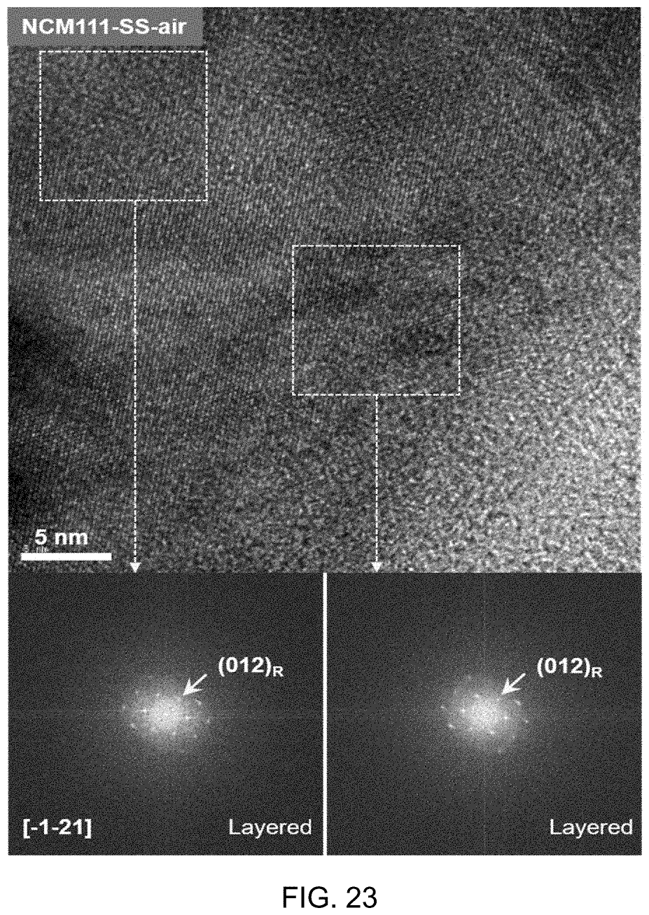

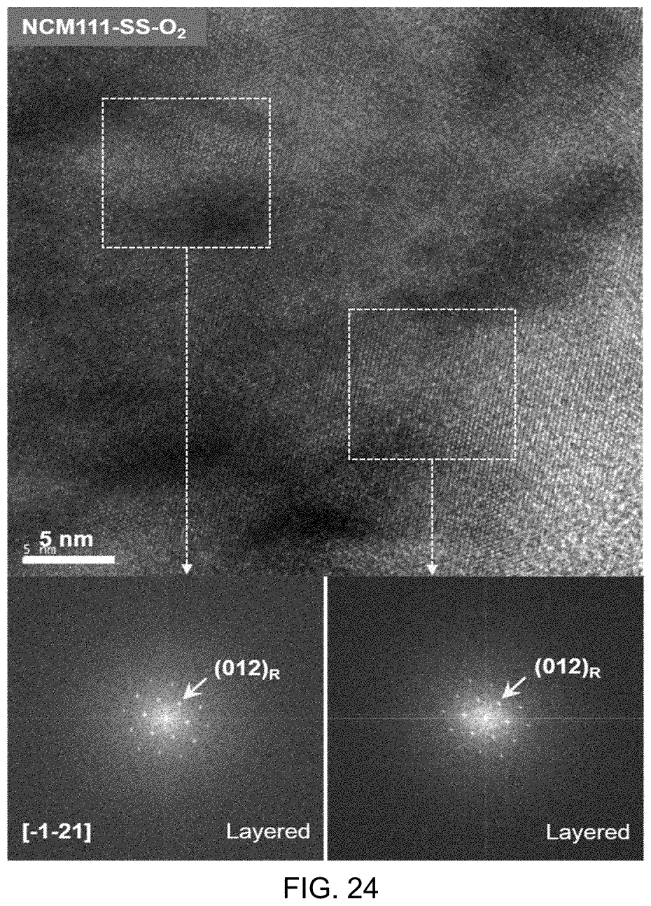

In addition, it was found that the change in microphase of NCM523 shows higher sensitivity to the oxygen partial pressure than NCM111 in SS regeneration. The SS in air can convert the spinel phase to layered phase in cycled NCM 111 cathode, as illustrated by the HR-TEM and FFT images of cycled NCM111-SS-air sample along the [-1-21] zone axis shown in FIG. 23. Both the bulk and the surface show layered rhombohedral structure with diffraction pattern showing (012) plane. However, for the NCM523 cathode, some rock salt phases can still be observed on the particle surface after SS in air (NCM523-SS-air samples in Panel (d) of FIG. 20), which indicates that the oxygen partial pressure is important for such a phase conversion. By comparison, for the SS in oxygen, no spinel or rock salt phase is observed, as shown by the NCM523-SS-oxygen samples in Panel (e) of FIG. 20, which means a successful regeneration of the layered structure in cycled NCM523 cathode. As expected, SS in oxygen can also fully recover the layered structure in cycled NCM111 cathode as well, as shown by the HR-TEM and FFT images of cycled NCM111-SS-oxygen sample along the [4-21] zone axis shown in FIG. 24. Both the bulk and the surface show layered rhombohedral structure with diffraction pattern showing (012) plane.

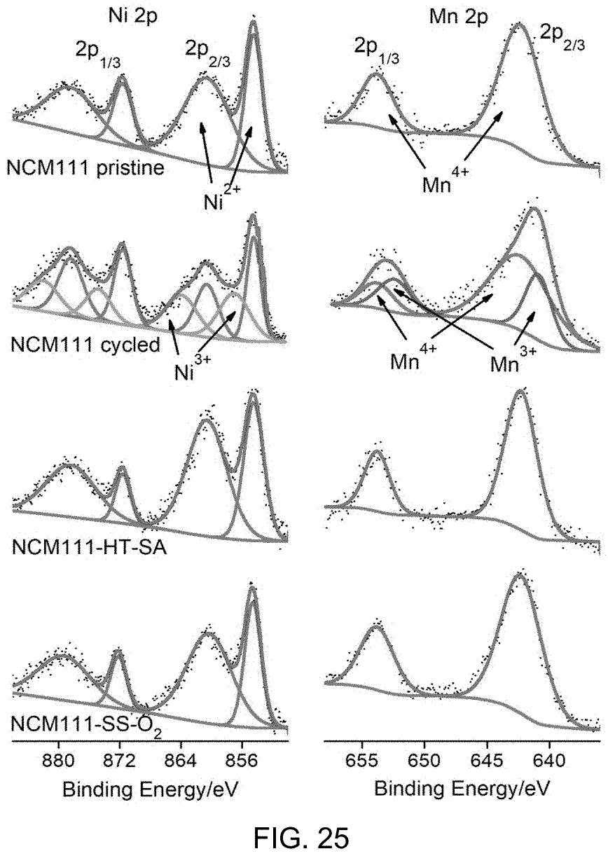

To provide further evidence of spinel/rock salt phase in the cycled cathodes and the successful reconstruction of the layered phase after regeneration, x-ray photoelectron spectroscopy (XPS) measurement was performed on NCM111 (as shown in FIG. 25) and NCM523 (as shown in Panel (f) of FIG. 20). FIG. 25 illustrates XPS patterns of pristine NCM111, cycled NCM111, NCM111-HT-SA, and NCM111-SS-oxygen samples. In Ni 2p spectra, Ni²⁺ peaks are observed in all NCM111 samples, while Ni³⁺ peaks are only observed in cycled NCM111 sample. In Mn 2p spectra, Mn⁴⁺ peaks are observed in all NCM111 samples, while Mn³⁺ peaks are only observed in cycled NCM111 samples. For Ni 2p spectra, all cathodes have two dominant peaks at 854.6 eV (2p3/2) and 872.2 eV (2p1/3) which represent Ni²⁺, and the two less dominant shake-up peaks at 860.9 eV and 879.2 eV further confirm the existence of Ni²⁺. In cycled NCM111 and all NCM523 cathodes, besides the existence of Ni²⁺, the less prominent peaks at 857.2, 864.3, 875.5 and 882.9 eV indicate the existence of Ni³⁺. The quantitative analysis shows that the Ni²⁺ concentration of NCM111-cycled, NCM523-pristine, NCM523-cycled, NCM523-HT-SA and NCM523-SS-oxygen samples are 55.14%, 60.22%, 72.56%, 60.37%, and 60.44%, respectively. The significantly higher Ni²⁺ concentration in the cycled NCM523 cathode is consistent with the existence of NiO rock salt phase on the surface by the TEM observation. For Mn 2p spectra, all samples have two major peaks at 642.3 eV (2p_{3/2}) and 653.8 (2p_{1/3}) which represent Mn⁴⁺. The peaks at 640.9 and 652.4 eV found in cycled NCM 111 and NCM523 samples indicate the existence of Mn³⁺, while such peaks were not observed in pristine and regenerated samples. The quantitative analysis of Mn 2p spectrum shows that the Mn' concentration is 34.58% and 36.54% in cycled NCM111 and NCM523 cathodes, respectively, which is expected because the layered to spinel/rock salt transformation originates from oxygen loss, and results in the formation of Mn³⁺ for charge compensation. Therefore, the existence of Mn³⁺ in cycled cathodes and its disappearance in regenerated cathodes further support that the spinel and rock salt phases formed after cycling was recovered into layered structure after regeneration.

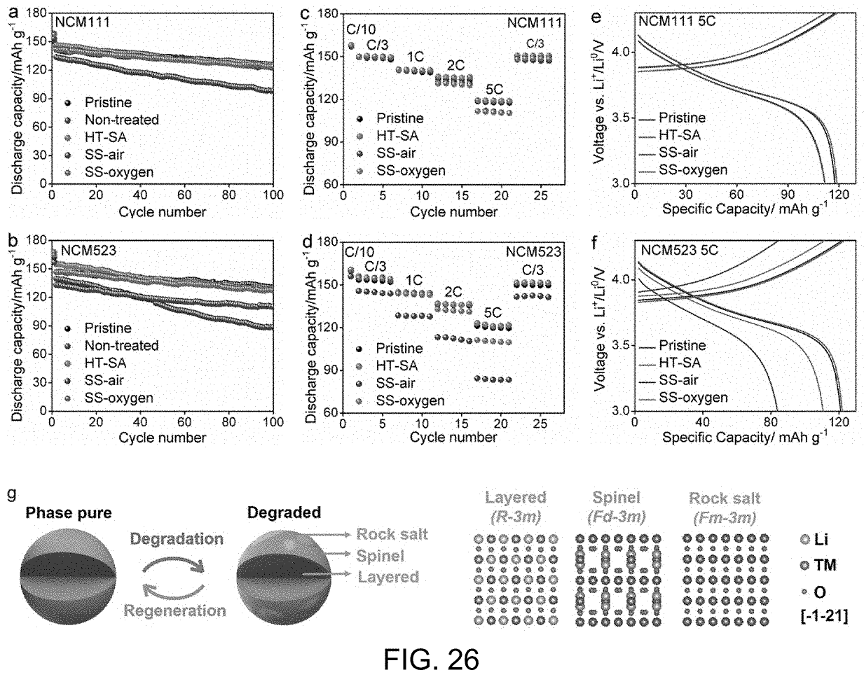

FIG. 26 illustrates various panels evaluating the electrochemical performance of the cathode particles. Panel (a): the cycling performance of pristine, non-treated and regenerated NCM111 samples at 1C; HT-SA: hydrothermal treatment at 220° C. for 4 h, followed by annealing at 850° C. for 4 h; SS-air: sintering at 850° C. for 12 h in air; SS-oxygen: sintering at 850° C. for 12 h in oxygen. Panel (b): the cycling performance of pristine, non-treated and regenerated NCM523 samples at 1C. Panel (c): the rate performance of NCM111 samples. Panel (d): the rate performance of NCM523 samples. Panel (e): voltage profiles of NCM111 samples at 5C. Panel (f): voltage profiles of NCM523 samples at Panel (c). Panel (g): illustration of the crystal structure change of NCM523 after cycling and regeneration. The right scheme in Panel (g) shows the atomic arrangement of layered, spinel and rock salt phases along the [4-21] zone axis (same as TEM images).

The electrochemical performance of the NCM111 and NCM523 cathode particles in different conditions were evaluated in the voltage range of 3-4.3 V at 1C (C=150 mA g−1) after one activation cycle at C/10. For NCM111 in Panel (a), the pristine cathode shows a capacity of 145.1 mAh g⁻¹ in the first cycle at 1C and 123.8 mAh g⁻¹ after 100 cycles. In Panel (b), the non-treated, cycled cathode shows a capacity of 98.4 mAh g⁻¹ after 100 cycles, which is due to the existence of spinel phase at the surface (see FIG. 15). The electrochemical activity of the regenerated cathodes from HT-SA, SS in air and SS in oxygen was fully recovered, with a capacity of 158.4, 153.3 and 157.4 in the first cycle at 1C and 122.6, 125.4, and 123.8 mAh g⁻¹ after 100 cycles, respectively. For NCM523, the pristine cathode shows a capacity of 146.6 mAh g−1 in the first cycle at 1C and 130.4 mAh g⁻¹ after 100 cycles (FIG. 26, Panel (b)). The non-treated, cycled cathode shows a poor cycling performance with only 88.6 mAh g⁻¹ capacity retention after 100 cycles. The fast capacity decay is consistent with the observed spinel and rock salt phase at the surface (FIG. 12, Panel (f)). After regeneration by HT-SA and SS in oxygen, the cycling stability of both cathodes was fully recovered and the regenerated cathodes can maintain a capacity of 128.3 mAh g⁻¹ (HT-SA) and 127.4 mAh g⁻¹ (SS) after 100 cycles. However, even though the SS in air increases the specific capacity and capacity retention of the regenerated cathode, it cannot fully recover the cycling performance. This is also consistent with the TEM observation (Panel (d) in FIG. 20) which shows rock salt phase remaining at the surface.

The rate capability and voltage profiles of the pristine and regenerated cathodes at 5C are compared in Panels (c), (d), (e) and (f) of FIG. 26. For both NCM111 and NCM523 samples, the HT-SA approach delivers better rate capability (Panels (c) and (d)), as well as smaller voltage drops and polarization (Panels (e) and (f)) than the SS approach. The rate capability of the NCM523-SS-oxygen sample is better than that of the NCM523-SS-air sample (Panel (d)), and the voltage drop and polarization of the former is smaller than the latter. The reason for the better rate capability of HT-SA samples is believed to relate to their lower Li/Ni mixing (Table 6). It was also reported before that hydrothermal treatment is effective to suppress the degree of Li/Ni mixing. Cation mixing blocks the Li⁺ transportation channel, and therefore decreases the rate capability. The different rate performance of NCM111-SS-air and NCM523-SS-air samples matches well with their microphase structures (FIG. 23 and Panel (d) of FIG. 20). The layered structure of NCM111-SS-air is recovered, while in NCM523-SS-air, the rock salt phase still exists, which results in the inhibition of Li⁺ motion.

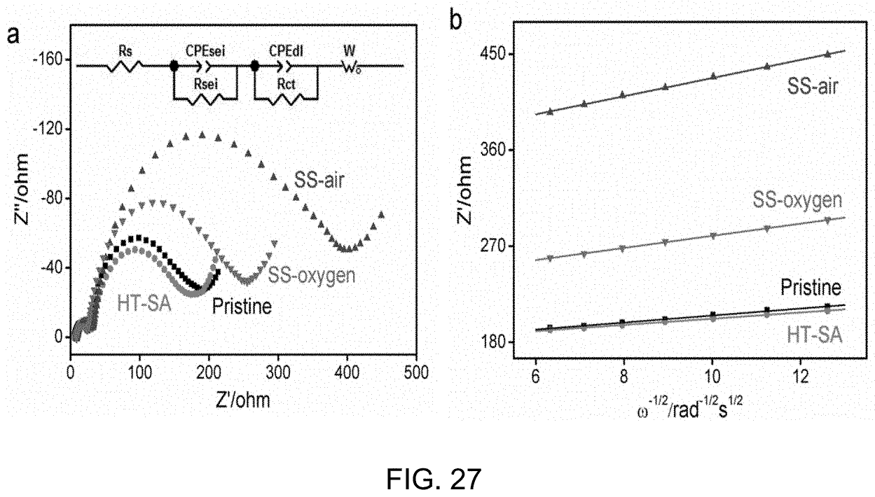

To further understand the rate performance, Electrochemical Impedance Spectroscopy (EIS) measurement was performed on pristine and regenerated NCM523 cathodes after 100 cycles at 1C. FIG. 27 illustrates Nyquist plots of pristine and regenerated NCM523 cathodes after 100 cycles (Panel (a)), where the inset displays the equivalent circuit to fit the Nyquist plots; and the relationship between the real parts of the complex impedance and ω^{-1/2} (Panel (b)). Rₛ, Rₛₑᵢ and R_{ct} are the ohmic resistance, solid electrolyte interface (SEI) resistance, and charge-transfer (CT) resistance, respectively. W is the Warburg impedance related to the Li⁺ diffusion. As Table 7 shows, the NCM523-SS-air sample has much larger charge-transfer resistance (R_{ct}) (367.4Ω) than the NCM523-SS-oxygen sample (198.7Ω); the NCM523-HT-SA sample has the smallest R_{ct} (142.8 Ω).

TABLE 7
Resistance values of pristine and regenerated
NCM523 cathodes after 100 cycles

| | Rₛ/Ω | Rₛₑᵢ/Ω | R_{ct}/Ω | D_{Li}⁺/cm²s⁻¹ |
|---|---|---|---|---|
| Pristine | 6.374 | 18.68 | 151.6 | 3.66 × 10⁻¹² |
| HT-SA | 6.963 | 21.72 | 142.8 | 4.85 × 10⁻¹² |
| SS-air | 8.855 | 22.95 | 367.4 | 5.55 × 10⁻¹³ |
| SS-oxygen | 8.019 | 21.87 | 198.7 | 1.22 × 10⁻¹² |

The superior rate performance of the HT-SA sample is attributed to its lowest R_{ct} which favors the charge-transfer reaction for Li⁺ intercalation. The linear part of Nyquist plot in the low frequency range is directly related to Li⁺ diffusion in electrode, and the diffusion coefficient (D_{Li}⁺) could be calculated by the EIS method using Warburg impedance (Table 7). The NCM523-HT-SA sample has the largest D_{Li}⁺ of 4.85×10⁻¹² cm² s⁻¹, and the NCM523-SS-oxygen sample has a larger D_{Li}⁺ (1.22×10⁻¹² cm² s⁻¹) than the NCM523-SS-air sample (5.55×10⁻¹³ cm² s⁻¹). The lower R_{ct} and higher D_{Li}⁺ of the regenerated cathode by the HT-SA approach explain its better rate capability than the cathode regenerated by the SS approach. The remaining rock salt phase and cation mixing on the surface of the regenerated NCM523 in air (Panel (d) of FIG. 20) leads to the large R_{ct} and low D_{Li}⁺.

Overall, degraded NCM particles with different compositional deficiencies and microphase impurities can be effectively regenerated using these direct methods that combine hydrothermal lithiation and short annealing, which leads to ideal stoichiometry, low cation mixing and high phase purity. Panel (g) of FIG. 26 simply illustrates such a reversible process for particles after cycling and regeneration, using the NCM523 cathode as the example. After extensive cycling, scattered rock salt phase forms at the surface of NCM523 cathode together with the spinel phase accompanying Li loss. With direct regeneration, the undesired spinel and rock phases are converted back to the layered phase with lithiation and thermal annealing.

C. Conclusions

In conclusion, the successful regeneration of the chemical composition and microstructure of degraded NCM cathodes using a novel particle-to-particle approach was demonstrated. Particularly, the perfect reconstruction of stoichiometry and microphase purity enabled by hydrothermal treatment with a short annealing provided the regenerated NCM cathode particles with high capacity, long cycling stability and high rate performance reaching their pristine materials, even with high Ni content. Due to the higher nickel content in NCM523 than NCM111 cathodes, the approach of direct solid-state sintering in air can restore the cycling stability of the latter but not the former. The oxygen partial pressure needs to be maintained high to effectively convert the rock salt phase impurities to the layered phase in NCM cathodes with high Ni content. Therefore, this work represents a simple yet efficient approach to directly regenerate high-performance NCM cathodes, with distinct advantages over traditional hydrometallurgical methods. This study also builds an important foundation for sustainable manufacturing of energy materials.

### REFERENCES

### Incorporated Herein By Reference

1. V. Etacheri, R. Marom, R. Elazari, G. Salitra and D. Aurbach, Energy Environ. Sci., 2011, 4, 3243.
2. X. Zheng, W. Gao, X. Zhang, M. He, X. Lin, H. Cao, Y. Zhang and Z. Sun, Waste Manage., 2017, 60, 680.
3. P. Patel, T. Ellis and J. Howes, MRS Bull., 2017, 42, 416.
4. J. Heelan, E. Gratz, Z. Zheng, Q. Wang, M. Chen, D. Apelian and Y. Wang, J. Miner. Met. Mater. Soc., 2016, 68, 2632.
5. S. Chen, T. He, Y. Lu, Y. Su, J. Tian, N. Li, G. Chen, L. Bao and F. Wu, J. Energy Storage, 2016, 8, 262.
6. D. P. Mantuano, G. Dorella, R. C. A. Elias and M. B. Mansur, J. Power Sources, 2006, 159, 1510.
7. L. Li, J. B. Dunn, X. X. Zhang, L. Gaines, R. J. Chen, F. Wu and K. Amine, J. Power Sources, 2013, 233, 180.
8. A. Iizuka, Y. Yamashita, H. Nagasawa, A. Yamasaki and Y. Yanagisawa, Sep. Purif. Technol. 2013, 113, 33.
9. H. Zou, E. Gratz, D. Apelian and Y. Wang, Green Chem., 2013, 15, 1183.
10. M. K. Jha, A. Kumari, A. K. Jha, V. Kumar, J. Hait and B. D. Pandey, Waste Manage., 2013, 33, 1890.
11. J. Chen, Q. Li, J. Song, D. Song, L. Zhang and X. Shi, Green Chem., 2016, 18, 2500.
12. A. S. Poyraz, J. Huang, S. Cheng, D. C. Bock, L. Wu, Y. Zhu, A. C. Marschilok, K. J. Takeuchi and E. S. Takeuchi, Green Chem., 2016, 18, 3414.
13. H. Nie, L. Xu, D. Song, J. Song, X. Shi, X. Wang, L. Zhang and Z. Yuan, Green Chem., 2015, 17, 1276.
14. S. Lou, B. Shen, P. Zuo, G. Yin, L. Yang, Y. Ma, X. Cheng, C. Du and Y. Gao, RSC Adv., 2015, 5, 81235.
15. S. G. Zhu, Y. Qin and J. Zhang, Int. J. Electrochem. Sci., 2016, 11, 6403.
16. Z. M. Zhang, W. Z. He, G. M. Li, J. Xia, H. K. Hu, J. W. Huang and S. B. Zhang, ECS Electrochem. Lett., 2014, 3, A58.
17. F. Wu, M. Wang, Y. Su, L. Bao and S. Chen, J. Power Sources, 2010, 195, 2362.
18. A. Lundblad and B. Bergman, Solid State Ionics, 1997, 96, 173.
19. J. R. Dahn, E. W. Fuller, M. Obrovac and U. von Sacken, Solid State Ionics, 1994, 69, 265.
20. L. Q. Zhang, L. X. Wang, C. Lyu, J. F. Li and J. Zheng, Energies, 2014, 7, 6282.
21. D. Aurbach, B. Markovsky, A. Rodkin, E. Levi, Y. S. Cohen, H. J. Kim and M. Schmidt, Electrochim. Acta, 2002, 47, 4291.
22. M. Broussely, P. Biensan, F. Bonhomme, P. Blanchard, S. Herreyre, K. Nechev and R. J. Staniewicz, J. Power Sources, 2005, 146, 90.
23. M. Sathiya, A. S. Prakash, K. Ramesha and A. K. Shukla, Materials, 2009, 2, 857.
24. A. Lundblad, S. Schwartz and B. Bergman, J. Power Sources, 2000, 90, 224.
25. T. M. T. N. Tennakoon, G. Lindbergh and B. Bergman, J. Electrochem. Soc., 1997, 144, 2296.
26. L. Wang, T. Maxisch and G. Ceder, Chem. Mater., 2007, 19, 543.
27. R. Hausbrand, G. Cherkashinin, H. Ehrenberg, M. Gröting, K. Albe, C. Hess and W. Jaegermann, Mater. Sci. Eng., B, 2015, 192, 3.
28. S. Choi and A. Manthiram, J. Electrochem. Soc., 2002, 149, A162.
29. S.T. Myung, M.H. Lee, S. Komaba, N. Kumagai and Y.K. Sun, Electrochim. Acta, 2005, 50, 4800.
30. Y. Zhu, J. You, H. Huang, G. Li, W. Zhou and J. Guo, Front. Mater. Sci., 2017, 11, 155.
31. D. Jiang, L. Zhao, Y. Shao and D. Wang, RSC Adv., 2015, 5, 40779.
32. V. G. Hadjiev, M. N. Iliev and I. V. Vergilov, J. Phys. C: Solid State Phys., 1988, 21, L199.
33. C. Zhu, C. Yang, W.-D. Yang, C. Y. Hsieh, H. M. Ysai and Y. S. Chen, J. Alloys Compd., 2010, 496, 703.
34. S. Soltanmohammad and S. Asgari, J. Nanomater., 2010, 2010, 104012.
35. B. Garcia, P. Barboux, F. Ribot, A. Kahn-Harari, L. Mazerolles and N. Baffler, Solid State Ionics, 1995, 80, 111.
36. H. Wang, Y. I. Jang, B. Huang, D. R. Sadoway and Y. M. Chiang, J. Electrochem. Soc., 1999, 146, 473.
37. E. Antolini, Solid State Ionics, 2004, 170, 159.
38. L. Xia, K. H. Qiu, Y. Y. Gao, X. He and F. D. Zhou, J. Mater. Sci., 2015, 50, 2914.
39. H. Matsumoto, N. Terasawa, S. Tsuzuki and H. Sakaebe, ECS Trans., 2011, 33, 37.
40. N. Ogihara, Y. Itou, T. Sasaki and Y. Takeuchi, J . Phys. Chem. C, 2015, 119, 4612.
41. A. M. Hashem, R. S. El-Taweel, H. M. Abuzeid, A. E. Abdel-Ghany, A. E. Eid, H. Groult, A. Mauger and C. M. Julien, Ionics, 2012, 18, 1.
42. L. Li, L. Wang, X. Zhang, M. Xie, F. Wu and R. Chen, ACS Appl. Mater. Interfaces, 2015, 7, 21939.
43. Z. Chen, J. Wang, D. L. Chao, T. Baikie, L. Y. Bai, S. Chen, Y. L. Zhao, T. C. Sum, J. Y. Lin and Z. X. Shen, Sci. Rep., 2016, 6, 1.
44. S. K. Jung, H. Gwon, J. Hong, K. Y. Park, D. H. Seo, H. Kim, J. Hyun, W. Yang and K. Kang, Adv. Energy Mater., 2014, 4, 1300787.
45. C. K. Lee and K. I. Rhee, J. Power Sources, 2002, 109, 17.
46. M. Jo, S. Jeong and J. Cho, Electrochem. Commun., 2010, 12, 992.
47. H. Kawaji, M. Takematsu, T. Tojo, T. Atake, A. Hirano and R. Kanno, J. Therm. Anal. Calorim., 2002, 68, 833.
48. L. V. Gurvich, G. A. Bergman, L. N. Gorokhov, V. S. Iorish, V. Y. Leonidov and V. S. Yungman, J. Phys. Chem. Ref. Data, 1996, 25, 1211.
49. C. A. Angell, W. J. Sichina and M. Oguni, J. Phys. Chem. A, 1982, 86, 998.
50. E. Stålnacke, Bachelor thesis, KTH Royal Institute of Technology, 2015.
51. V. Etacheri, R. Marom, R. Elazari, G. Salitra and D. Aurbach. Energy Environ. Sci. 2011, 4, 3243.
52 X. Zheng, W. Gao, X. Zhang, M. He, X. Lin, H. Cao, Y. Zhang and Z. Sun, Waste Manage. 2017, 60, 680.
53 P. Patel, T. Ellis and J. Howes, MRS Bull. 2017, 42, 416.
54 J. Heelan, E. Gratz, Z. Zheng, Q. Wang, M. Chen, D. Apelian and Y. Wang, JOM 2016, 68, 2632.
55 X. Chen, C. Luo, J. Zhang, J. Kong and T. Zhou, ACS Sustainable Chem. Eng. 2015, 3, 3104.
56 S. Ahmed, P. A. Nelson, K. G. Gallagher, N. Susarla and D. W. Dees, J. Power Sources 2017, 342, 733.
57 S. Chen, T. He, Y. Lu, Y. Su, J. Tian, N. Li, G. Chen, L. Bao, and F. Wu, J. Storage Mater. 2016, 8, 262.
58 D. P. Mantuano, G. Dorella, R. C. A. Elias and M. B. Mansur, J. Power Sources 2006, 159, 1510.
59 L. Li, J. B. Dunn, X. X. Zhang, L. Gaines, R. J. Chen, F. Wu and K. Amine, J. Power Sources 2013, 233, 180.
60 A. Iizuka, Y. Yamashita, H. Nagasawa, A. Yamasaki and Y. Yanagisawa, Sep. Purif Technol. 2013, 113, 33.
61 H. Zou, E. Gratz, D. Apelian and Y. Wang, Green Chem. 2013, 15, 1183.
62 M. K. Jha, A. Kumari, V. Kumar, J. Hait, and B. D. Pandey, Waste Manage. 2013, 33, 1890.
63 H. Nie, L. Xu, D. Song, J. Song, X. Shi, X. Wang, L. Zhang, and Z. Yuan, Green Chem. 2015, 17, 1276.
64 X. Li, J. Zhang, D. Song, J. Song and L. Zhang, J. Power Sources 2017, 345, 78.
65 Y. Shi, M. Zhang, D. Qian, and Y. S. Meng, Electrochim. Acta 2016, 203, 154.
66 Q. Sa, E. Gratz, M. He, W. Lu, D. Apelian, and Y. Wang, J. Power Sources 2015, 282, 140.
67 Q. Sa, E. Gratz, J. A. Heelan, S. Ma, D. Apelian, and Y. Wang, J. Sustainable Metall. 2016, 2, 248.
68 L. Li, E. Fan, Y. Guan, X. Zhang, Q. Xue, L. Wei and F. Wu, ACS Sustainable Chem. Eng. 2017, 5, 5224.
69 L. Li, Y. Bian, X. Zhang, Y. Guan, D. Fan, F. Wu and R. Chen, Waste Manage. 2018, 71, 362.
70 L. Li, Y. Bian, X. Zhang, Q. Xue, E. Fan, F. Wu, F. and R. Chen, J. Power Sources 2018, 377, 70.
71 Y. Shi, G. Chen and Z. Chen, Green Chem. 2018, 20, 851.
72 S. K. Jung, H. Gwon, J. Hong, K. Y. Park, D. H. Seo, H. Kim, J. Hyun, W. Yang and K. Kang, Adv. Energy Mater. 2014, 4, 1300787.
73 P. Verma, P. Maire and P. Novák, Electrochim. Acta 2010, 55, 6332.
74 R. Hausbrand, G. Cherkashinin, H. Ehrenberg, M. Gröting, K. Albe, C. Hess and W. Jaegermann, Mater. Sci. Eng., B 2015, 192, 3.
75 H. Gabrisch, R. Yazami and B. Fultz, J. Electrochem. Soc. 2004, 151, A891.
76 A. Yano, M. Shikano, A. Ueda, H. Sakaebe and Z. Ogumi, J. Electrochem. Soc. 2017, 164, A6116.
77 F. Lin, I. M. Markus, M. Doeff, H. L. Xin, Sci. Rep. 2014, 4, 5694.
78 S. T. Myung, F. Maglia, K. J. Park, C. S. Yoon, P. Lamp, S. J. Kim, Y. K. Sun, ACS Energy Lett. 2017, 2, 196.
79 J. Zheng, P. Yan, J. Zhang, M. H. Engelhard, Z. Zhu, B. J. Polzin, S. Trask, J. Xiao, C. Wang and J. Zhang, Nano Res. 2017, 10, 4221.
80 L. Wu, K. W. Nam, X. Wang, Y. Zhou, J. C. Zheng, X. Q. Yang and Y. Zhu, Chem. Mater. 2011, 23, 3953.
81 H. Kobayashi, M. Shikano, S. Koike, H. Sakaebe, K. Tatsumi, J. Power Sources 2007, 174, 380.
82 J. Nanda, J. Remillard, A. O'Neill, D. Bernardi, T. Ro, K. E. Nietering, J. Y. Go, and T. J. Miller, Adv. Funct. Mater. 2011, 21, 3282.
83 G. Ceder and A. Van der Ven, Electrochim. Acta 1999, 45, 131.
84 R. Shannon, Acta Crystallogr., Sect. A: Found. Crystallogr. 1976, 32, 751.
85 Y. Zou, X. Yang, C. Lv, T. Liu, Y. Xia, L. Shang, G. I. N. Waterhouse, D. Yang and T. Zhang, Adv. Sci. 2017, 4, 1600262.
86 H. Liu, Y. Yang and J. Zhang, J. Power Sources 2007, 173, 556.
87 K. Yang, L. Z. Fan, J. Guo and X. Qu, Electrochim. Acta 2012, 63, 363.
88 D. Mohanty, S. Kalnaus, R. A. Meisner, K. J. Rhodes, J. Li, E. A. Payzant, D. L. Wood, C. Daniel, J. Power Sources 2013, 229, 239.
89 Mohanty, H. Gabrisch, J. Power Sources 2012, 220, 405.
90 Zhang, A. Mauger, Q. Lu, H. Groult, L. Perrigaud, F. Gendron and C. M. Julien, Electrochim. Acta 2010, 55, 6440.
91 H. Zhang, F. Omenya, P. Yan, L. Luo, M. S. Whittingham, C. Wang and G. Zhou, ACS Energy Lett. 2017, 2, 2607.
92 J. Li, S. Xiong, Y. Liu, Z. Ju, and Y. Qian, Nano Energy 2013, 2, 1249.
93 Z. Chen, J. Wang, D. Chao, T. Baikie, L. Bai, S. Chen, Y Zhao, T. C. Sum, J. Lin, and Z. Shen, Sci. Rep. 2016, 6, 25771.
94 B. J. Tan, K. J. Klabunde and P. M .A. Sherwood, J. Am. Chem. Soc. 1991, 113, 855.
95 L. Ben, H. Yu, B. Chen, Y. Chen, Y. Gong, X. Yang, L. Gu and X. Huang, ACS Appl. Mater. Interfaces 2017, 9, 35463.
96 Y. Chen, P. Li, Y. Li, Q. Su, L. Xue, Q. Han, G. Cao and J. Li, J. Mater. Sci. 2018, 53, 2115.
97 B. S. Liu, Z. B. Wang, F. D. Yu, Y. Xue, G. J. Wang, Y. Zhang and Y. X. Zhou, RSC Adv. 2016, 6, 108558.
98 N. Ogihara, Y. Itou, T. Sasaki and Y. Takeuchi, J. Phys. Chem. C 2015, 119, 4612.
99 L. Xia, K. H. Qiu, Y. Y. Gao, X. He and F. D. Zhou, J. Mater. Sci. 2015, 50, 2914.
100 A. J. Bard and L. R. Faulkner, Electrochemical Methods (2nd Ed.); Wiley: New York, U.S.; 2001

What is claimed is:

1. A method for regenerating degraded lithium-ion battery cathode materials, the method comprising:
pre-dosing lithium (Li) into Li-deficient cathode particles in a Li-containing salt solution;
performing a hydrothermal treatment on the salt solution; and
thermally annealing the hydrothermally treated salt solution to create regenerated cathode particles.

2. The method of claim 1, wherein the cathode materials are degraded LiCoO₂ (LCO) particles.

3. The method of claim 1, wherein the salt solution is lithium hydroxide (LiOH).

4. The method of claim 3, wherein the salt solution is LiOH and one or more of lithium sulfate (Li₂SO₄), lithium chloride (LiCl) and lithium nitrate (LiNO₃).

5. The method of claim 1, wherein the salt solution includes an alkaline solution of sodium hydroxide (NaOH), potassium hydroxide (KOH), ammonium hydroxide (NH₄OH) or a mixture thereof.

6. The method of claim 1, further comprising performing the hydrothermal treatment at a temperature of approximately 220 degrees Celsius (° C.) for approximately 4 hours.

7. The method of claim 6, further comprising performing the hydrothermal treatment at a temperature of approximately 120-240° C. for approximately 1-24 hours.

8. The method of claim 6, further comprising annealing the hydrothermally treated salt solution in an air or oxygen environment at approximately 700-950° C. for approximately 1-24 hours.

9. The method of claim 8, further comprising annealing the hydrothermally treated salt solution in an air or oxygen environment at approximately 850° C. for approximately 4 hours.

10. The method of claim 9, further comprising annealing the particles with an excess amount of lithium carbonate and/or lithium hydroxide.

11. The method of claim 10, further comprising processing the regenerated cathode materials into a slurry.

12. The method of claim 1, wherein the Li-containing salt solution is approximately 0.001-5 mole (M).

13. The method of claim 12, wherein the lithium ion concentration of the Li-containing salt solution is approximately 4 M.

14. A method for regenerating degraded LiNiₓCo_{y}Mn_{z}O₂ (NCM) cathode particles, comprising:
pre-dosing lithium (Li) into Li-deficient cathode particles in a Li-containing salt solution;
exposing the Li-containing salt solution to a hydrothermal treatment; and
thermally annealing the hydrothermally treated salt solution to produce regenerated cathode particles.

15. The method of claim 14, wherein the cathode materials are degraded LiCoO₂ (LCO) particles.

16. The method of claim 14, wherein the salt solution is lithium hydroxide (LiOH).

17. The method of claim 16, wherein the salt solution is LiOH and one or more of lithium sulfate (Li₂SO₄), lithium chloride (LiCl) and lithium nitrate (LiNO₃).

18. The method of claim 14, wherein the salt solution includes an alkaline solution of sodium hydroxide (NaOH), potassium hydroxide (KOH), ammonium hydroxide (NH₄OH) or a mixture thereof.

19. The method of claim 14, further comprising performing the hydrothermal treatment at a temperature of approximately 120-240 degrees Celsius (° C.) for approximately 1-2 hours.

20. The method of claim 19, further comprising annealing the hydrothermally treated salt solution in an air or oxygen environment at approximately 700-950° C. for approximately 1-2 hours.

21. The method of claim 20, further comprising annealing the hydrothermally treated salt solution in an air or oxygen environment at approximately 850° C. for approximately 4 hours.

22. The method of claim 14, further comprising annealing the hydrothermally treated salt solution with an excess amount of lithium carbonate and/or lithium hydroxide.

23. The method of claim 14, wherein the Li-containing salt solution solution is approximately 0.001-5 mole (M).

24. The method of claim 23, wherein the Li-containing salt solution is approximately 4 M.
